(19) United States
(12) Patent Application Publication
(10) Pub. No.: US 2022/0251434 A1
(43) Pub. Date: Aug. 11, 2022

(54) TWO-COMPONENT ADHESIVE COMPOSITION COMPRISING AN ORGANOBORANE AMINE COMPLEX

(71) Applicant: BOSTIK SA, Colombes (FR)

(72) Inventors: Guillaume MICHAUD, VENETTE (FR); Colombine POIVRET, VENETTE (FR); Bruno DELMOTTE, VENETTE (FR); Boris COLIN, VENETTE (FR)

(21) Appl. No.: 17/626,145

(22) PCT Filed: Jul. 9, 2020
(86) PCT No.: PCT/FR2020/051235

§ 371 Date: Jan. 11, 2022

(30) Foreign Application Priority Data
Jul. 18, 2019 (FR) FR1908162

(51) Int. Cl. C09J 175/14; C08G 18/32; C08G 18/16; C08G 18/10

(52) U.S. Cl. CPC C09J 175/14; C08G 18/3228; C08K 5/55; C08G 18/10; C08G 18/168

(57) ABSTRACT

The invention relates to a two-component composition comprising:
a part A comprising a complex of organoborane with an amine;
a part B comprising a polymer comprising at least one acrylic group and at least one isocyanate group;

the composition comprising at least one acrylic monomer or oligomer in part A and/or in part B of the composition.

The invention also relates to the use of said composition as an adhesive for binding two substrates together.

### FIELD OF INVENTION

The present invention relates to a two-component composition and also to the uses of said composition. The invention also relates to articles manufactured with this composition and to methods for preparing said articles.

### TECHNICAL BACKGROUND

The nature of the surface of a substrate can be characterized by its surface energy. Low surface energy substrates, such as polyolefins (polyethylene, polypropylene, polybutene, polyisoprene, polybutadiene, polyfarnesene, polymyrcene, polydicyclopentadiene and the copolymers thereof or mixtures thereof), polyvinyl fluoride (PVF), polyvinylidene fluoride (PVDF), polytetrafluoroethylene (PTFE), are known to be difficult to bond to each other or to other types of substrates and often require surface treatment prior to bonding. This is because they have very few bonding sites available on their free surface. These treatments, such as a plasma or corona treatment, an abrasion treatment or a treatment with a chemical agent, consist in chemically and/or physically modifying the surface of the substrate in order to favorably modify its surface energy.

However, this type of treatment has a certain number of disadvantages, such as a high process cost, results which are not necessarily reproducible, and an effect which diminishes over time.

Recently, it has been discovered that the use of adhesive compositions comprising organoboranes makes it possible to improve the adhesion of compounds that can be polymerized by a radical route on low-energy surfaces. However, due to the unstable and pyrophoric nature of organoboranes, they must be complexed with an amine in order to avoid oxidative decomposition. Thus, when using this type of composition, a decomplexing agent releases the organoborane from the amine so that it can initiate the polymerization of a radically polymerizable compound present in the composition. This type of composition is often in the form of two parts (one comprising the organoborane-amine complex and one comprising the decomplexing agent) which are mixed just before the use and application of the composition. The radically polymerizable compound can be present in at least one of the two compositions.

In general, the decomplexing agent can react with the amine of the organoborane-amine complex to release the organoborane, which will then be able to initiate the polymerization of the polymerizable compound. Thus, after crosslinking, the two-component composition comprises a first type of compound/polymer, i.e. the decomplexing agent which has reacted with the amine, and a second type of compound/polymer, i.e. the polymer formed from the polymerizable compound. Consequently, the polymer network of the crosslinked composition is not homogeneous and exhibits a certain fragility which can influence the adhesive properties of the composition.

Document WO 2016/077166 relates to a two-part composition comprising a first part comprising an organoborane-amine complex and a reactive diluent, and a second part comprising a decomplexing agent for decomplexing the organoborane-amine complex and at least one polymerizable compound comprising an ethylenic unsaturated bond.

Document WO 2009/120588 describes a two-part adhesive composition comprising an organoborane-amine complex, a polyamine, a radically polymerizable compound and an isocyanate compound. A prepolymer having isocyanate ends may advantageously be used. These compositions are particularly suitable for the adhesion of substrates having a low surface energy.

WO 2017/115697 relates to an adhesive composition used for binding low surface energy substrates, such as polypropylene. According to this document, the adhesive composition comprises a compound comprising an unsaturated polymerizable group, such as a methacrylic monomer, a reducing agent and a polyamine.

Document U.S. Pat. No. 6,008,308 describes a composition comprising an organoborane-polyamine complex, a polyol and an isocyanate compound. The composition may also comprise a bifunctional compound comprising a radically polymerizable group and a group which is reactive with an amine. This composition is used to initiate polymerization of an acrylic monomer and to form polyurethane/polyurea acrylic adhesives.

WO 2019/046200 describes a two-part polymerizable adhesive composition comprising an organoborane-monoamine complex, a free polyol, at least one radically polymerizable compound, a urethane having isocyanate ends, a free isocyanate and a low molecular weight chain extension compound.

Document US 2007/0135601 relates to complexes of organoboranes with amino-functional organosilyl compounds which are effective polymerization initiators for radical polymerization, in particular for acrylate and methacrylate adhesives. These complexes are particularly suitable for the adhesion of substrates having a low surface energy.

Document US 2015/0232686 describes an adhesive composition comprising at least one organic polymer, at least one monomer chosen from the group comprising acrylates, at least one catalyst chosen from the group comprising organic tertiary amines, and at least one solvent.

Document WO 2014/140138 relates to a polymerizable composition comprising a polymerizable acrylate or methacrylate compound, an organoborane polymerization initiator compound, a vinyl ether compound, and an activator for the organoborane compound. The composition exhibits good storage stability and good adhesive properties, in particular when it is used for adhesion on low-energy surfaces.

Document US 2015/0259568 relates to aqueous dispersions of polyurethanes which can be polymerized by UV irradiation. There is therefore a real need to provide a composition enabling improved adhesion, in particular on and between substrates having a low surface energy, the two-component composition comprising, after crosslinking, a homogeneous and strong polymer network.

### SUMMARY OF THE INVENTION

The invention relates first to a two-component composition comprising:

a part A comprising a complex of organoborane with an amine;

a part B comprising a polymer comprising at least one acrylic group and at least one isocyanate group;

the composition comprising at least one acrylic monomer or oligomer in part A and/or in part B of the composition. According to certain embodiments, the organoborane is of formula (I):

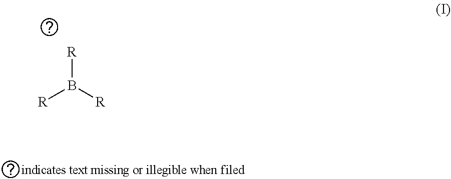

in which R′, R″ and R′″ independently represent a group comprising from 1 to 20 carbon atoms, the group being linear or branched and being chosen from an alkyl group, a cycloalkyl group, or an aryl group.

According to certain embodiments, the organoborane is triethylborane or tri-n-butylborane, or tri-sec-butylborane.

According to certain embodiments:
the amine is of formula (II):

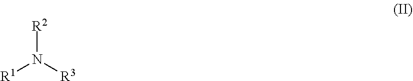

in which R¹, R² and R³ independently represent a hydrogen atom or a group comprising from 1 to 20 carbon atoms, the group being linear or branched and saturated or unsaturated and being chosen from an alkyl group, a cycloalkyl group, or an aryl group;
   or the amine is of formula (III):

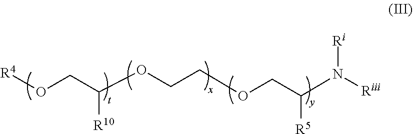

in which R⁴, R⁵ and R¹⁰ independently represent a hydrogen atom or a group comprising from 1 to 10 carbon atoms, the group being linear or branched and saturated or unsaturated and being chosen from an alkyl group, a cycloalkyl group, or an aryl group, Rⁱ and Rⁱⁱ independently represent a hydrogen atom or a group comprising from 1 to 20 carbon atoms, the group being linear or branched and saturated or unsaturated and being chosen from an alkyl group, a cycloalkyl group, an aryl group, or an arylalkyl group, and t, x and y independently represent a number from 0 to 90, preferentially from 0 to 70, preferentially from 0 to 50, and even more preferentially from 0 to 30;
   or the amine is of formula (IV):

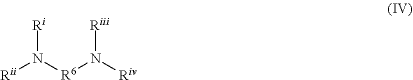

in which R⁶ represents a divalent group comprising from 2 to 60 carbon atoms, and preferably from 2 to 40 carbon atoms, the group being linear or branched and saturated or unsaturated and being chosen from a divalent alkyl radical, a divalent cycloalkyl radical, a divalent arylalkyl radical, or a divalent aryl radical, and Rⁱ, Rⁱⁱ, Rⁱⁱⁱ and R^{iv} independently represent a hydrogen atom or a group comprising from 1 to 20 carbon atoms, the group being linear or branched and saturated or unsaturated and being chosen from an alkyl group, a cycloalkyl group, an aryl group, or an arylalkyl group;
   or the amine is of formula (V):

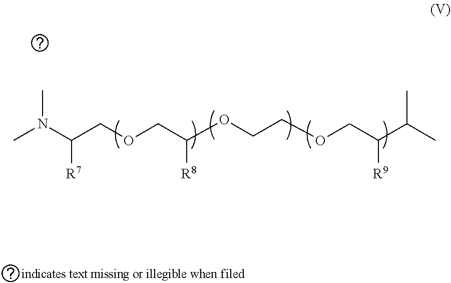

in which R⁷, R⁸ and R⁹ independently represent a group comprising from 1 to 10 carbon atoms, the group being linear or branched and saturated or unsaturated and being chosen from an alkyl group, a cycloalkyl group, or an aryl group, Rⁱ, Rⁱⁱ, Rⁱⁱⁱ and R^{iv} independently represent a hydrogen atom or a group comprising from 1 to 20 carbon atoms, the group being linear or branched and saturated or unsaturated and being chosen from an alkyl group, a cycloalkyl group, an aryl group, or an arylalkyl group, and v, w and z independently represent a number from 0 to 90 and even more preferentially from 0 to 70;
   or the amine is of formula (VI):

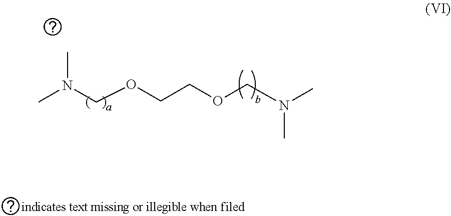

in which Rⁱ, Rⁱⁱ, Rⁱⁱⁱ and R^{iv} independently represent a hydrogen atom or a group comprising from 1 to 20 carbon atoms, the group being linear or branched and saturated or unsaturated and being chosen from an alkyl group, a cycloalkyl group, an aryl group, or an arylalkyl group; a and b independently represent a number from 1 to 20 and preferably from 2 to 11;
   or the amine is of formula (VII):

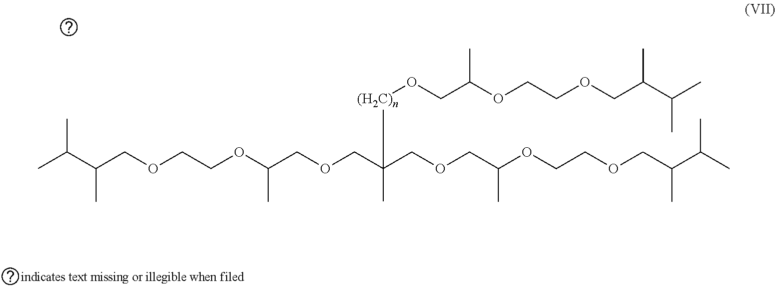

in which R₁⁸, R₁⁹, R₂⁸, R₂⁹, R₂⁹, R₃⁸, and R₃⁹ independently represent a group comprising from 1 to 10 carbon atoms, the group being linear or branched and being chosen from an alkyl group, a cycloalkyl group, or an aryl group, R represents a hydrogen atom or a group comprising from 1 to 10 carbon atoms, the group being linear or branched and being chosen from an alkyl group, a cycloalkyl group, an aryl group, or an arylalkyl group, Rⁱ, Rⁱⁱ, Rⁱⁱⁱ and R^{iv} independently represent a hydrogen atom or a group comprising from 1 to 20 carbon atoms, the group being linear or branched and saturated or unsaturated and being chosen from an alkyl group, a cycloalkyl group, an aryl group, or an arylalkyl group, n represents a number from 0 to 30 and preferably equal to 0 or 1 and the sums z₁+z₂+z₃, v₁+v₂+v₃ and w₁+w₂+w₃ independently represent a number from 0 to 90, preferentially from 0 to 70, preferentially from 0 to 50 and even more preferentially from 0 to 30.
According to certain embodiments, the amine is chosen from tert-butylamine, 3-methoxypropylamine, 1,3-propanediamine, 1,6-hexanediamine, and diethylenetriamine.

According to certain embodiments, the organoborane complex with the amine is triethylborane-1,3-diaminopropane, tri-n-butylborane-3-methoxypropylamine , triethylborane-diethylenetriamine, tri-n-butylborane-1,3-diaminopropane, tri-sec-butylborane-1,3-diaminopropane and triethylborane-1,6-hexanediamine.

According to certain embodiments, the complex of organoborane with an amine is present in part A at a content by mass of 5% to 100%, preferably of 5% to 50%, and more preferably of 10% to 30%, relative to the total of part A.

According to certain embodiments, the polymer comprising at least one acrylic group and at least one isocyanate group is a polyurethane.

According to certain embodiments, the polymer comprising at least one acrylic group and at least one isocyanate group has a number-average molecular mass of 500 to 50 000 g/mol.

According to certain embodiments, the polymer comprises from 0.5 to 4 acrylic groups per mole of polymer, preferentially from 1 to 2.5 acrylic groups per mole of polymer.

According to certain embodiments, the polymer comprises from 0.5 to 3 isocyanate groups per mole of polymer, preferentially from 1 to 2.5 isocyanate groups per mole of polymer.

According to certain embodiments, the acrylic group is chosen from acrylic esters and acrylamides, and preferably the acrylic group is a methacrylic group chosen from methacrylic esters and methacrylamides.

According to certain embodiments, the polymer comprising at least one acrylic group and at least one isocyanate group is present in part B at a content by mass of 1% to 70% and preferably of 1% to 40%, relative to the total of part B.

According to certain embodiments, the acrylic monomer or oligomer is a methacrylic monomer or oligomer.

According to certain embodiments, the acrylic monomer or oligomer is present at a content by mass of 0.01% to 70%, and preferably of 1% to 60%, relative to the total of part A and/or of part B of the composition.

According to certain embodiments, the composition additionally comprises a decomplexing agent for decomplexing the organoborane and the amine, the decomplexing agent being an isocyanate.

According to certain embodiments, the decomplexing agent is present in part B of the composition at a content by mass of 0.01% to 70%, and preferably of 0.1% to 40%, relative to the total of part B of the composition.

According to certain embodiments, part A comprises at least one additional amine chosen from a monoamine or a polyamine, preferably at a content by mass of 0.01% to 30%.

According to certain embodiments, the composition additionally comprises one or more additives chosen from fillers, plasticizers, tackifying resins, solvents, UV stabilizers, moisture absorbers, fluorescent materials and rheological additives.

According to certain embodiments, the mass ratio of part A to part B is from 0.05 to 10, and preferably from 0.1 to 1.

The invention also relates to the use of the above-described composition as an adhesive for binding two substrates together.

The invention also relates to the use of the above-described composition as a coating on the surface of a substrate.

The invention also relates to the use of the above-described composition as a primer on the surface of a substrate.

According to certain embodiments, the substrate or at least one of the two substrates has a surface energy of less than or equal to 45 mJ/m², preferably of less than or equal to 40 mJ/m², and more preferably of less than or equal to 35 mJ/m².

According to certain embodiments, the substrate or at least one of the two substrates consists of polyolefin(s), preferably chosen from polyethylene, polypropylene, polybutene, polyisoprene, polybutadiene, polyfarnesene, polymyrcene, polyvinyl fluoride, polyvinylidene fluoride, polytetrafluoroethylene and the copolymers thereof or mixtures thereof.

The invention also relates to an article comprising at least one layer obtained by crosslinking the composition described above.

According to certain embodiments, the layer is an adhesive layer.

The invention also relates to a method for preparing the article described above, comprising:
mixing part A with part B of the composition; and
coating this mixture on the surface of a substrate;
optionally bringing this surface into contact with the surface of an additional substrate.

The invention also relates to a method for preparing the article described above, comprising:
coating one of parts A or B of the composition on the surface of a substrate; and
coating the second of parts A or B of the composition on the surface of the substrate;
optionally bringing this surface into contact with the surface of an additional substrate.

The present invention makes it possible to meet the need expressed above. It more particularly provides a composition enabling improved adhesion, in particular on and between substrates having a low surface energy, the two-component composition comprising, after crosslinking, a homogeneous and strong polymer network.

This is accomplished by virtue of the use of a two-component composition (or kit) comprising a polymer having both acrylic groups and isocyanate groups. Thus, on the one hand the isocyanate groups of the polymer can react with the amine of the organoborane-amine complex, and on the other hand the acrylic groups can be polymerized by the organoborane. A single homogeneous polymer network is therefore created during the crosslinking of the composition, this network being stronger and making it possible to obtain compositions having improved adhesive properties.

### DETAILED DESCRIPTION

The invention is now described in greater detail and in a nonlimiting way in the description which follows.

The invention relates to a two-component composition comprising a first part (part A) and a second part (part B).

### Borane-Amine Complex

The two-component composition, and more particularly part A of the two-component composition, comprises a complex of organoborane with an amine.

The term “organoborane” is understood to mean a compound comprising at least one boron atom bonded to at least one carbon atom.

The organoborane according to the invention can be of formula (I):

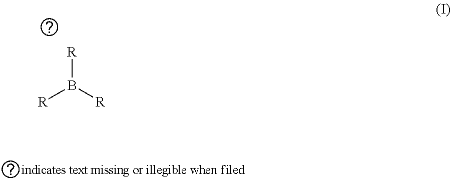

R′, R″ and R′″ may independently represent a group comprising from 1 to 20 carbon atoms, preferably from 1 to 10 carbon atoms, and more preferably from 1 to 5 carbon atoms. For example, R′, R″ and R′″ may independently represent a group comprising from 1 to 2; or from 2 to 4; or from 4 to 6; or from 6 to 8; or from 8 to 10; or from 10 to 12; or from 12 to 14; or from 14 to 16; or from 16 to 18; or from 18 to 20 carbon atoms.

R′, R″ and R′″ may be linear or branched.

According to certain embodiments, R′, R″ and R′″ may independently be chosen from an alkyl group, a cycloalkyl group, or an aryl group. By way of example, R′, R″ and R′″ may independently be a methyl group, an ethyl group, an n-propyl group, an isopropyl group, a cyclopropyl group, a tert-butyl group, an isobutyl group, an n-butyl group, a sec-butyl group, a cyclobutyl group, a cyclopentyl group, a cyclohexyl group, an alkyl group substituted by an aryl group such as an alkyl phenyl, a phenyl group which is unsubstituted or substituted by one or more groups such as an alkyl or cycloalkyl group, an alkoxy group, a halogen, a nitro group, and a carbonyl group, a naphthyl group which is unsubstituted or substituted by one or more groups such as an alkyl or cycloalkyl group, an alkoxy group, a halogen, a nitro group, and a carbonyl group, a heteroaryl group which is unsubstituted or substituted by one or more groups such as an alkyl or cycloalkyl group, an alkoxy group, a halogen, a nitro group, and a carbonyl group. As examples of heteroaryl groups, mention may be made of pyridines, pyrroles, carbazoles, imidazoles, furans, pyrans and thiophenes. Alternatively, two of R′, R″ and R′″ may form part of a ring.

Preferably, R′, R″ and R′″ are alkyl groups, preferably having from 1 to 5 carbon atoms.

According to certain embodiments, the groups R′, R″ and R′″ are different from one another.

According to other embodiments, at least two of the groups R′, R″ and R′″ are identical.

According to other, preferred, embodiments, R′, R″ and R′″ are identical. For example, preferably, R′, R″ and R′″ may be ethyl groups, or n-butyl groups, or sec-butyl groups. Thus, the organoborane may preferably be chosen from triethylborane, tri-n-butylborane, and tri-sec-butylborane.

Since the organoborane is a highly reactive molecule, its complexation with an amine is necessary in order to avoid its decomposition and in order to enable its storage.

The amine may be a monoamine (comprising a single amine group) or a polyamine (comprising more than one amine group, for example two, three or four amine groups). In the case of polyamines comprising a main chain, the amine groups may be present at the ends of the main chain and/or in the form of side or pendant groups along the main chain.

When the amine is a monoamine, it may be chosen from a primary, secondary or tertiary monoamine.

According to certain embodiments, the monoamine can be of formula (II):

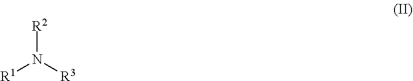

R¹, R² and R³ may independently represent a hydrogen atom or a group comprising from 1 to 20 carbon atoms. This group may be linear or branched and saturated or unsaturated.

According to certain embodiments, R¹, R² and R³ may independently be chosen from an alkyl group, a cycloalkyl group, an aryl group, an alkylaryl group, or an arylalkyl group. By way of example, R¹, R² and R³ may independently be a methyl group, an ethyl group, an n-propyl group, an isopropyl group, a cyclopropyl group, a tert-butyl group, an isobutyl group, an n-butyl group, a sec-butyl group, a cyclobutyl group, a cyclopentyl group, a cyclohexyl group, an alkyl group substituted by an aryl group such as an alkyl phenyl, a phenyl group which is unsubstituted or substituted by one or more groups such as an alkyl or cycloalkyl group, an alkoxy group, a halogen, a nitro group, and a carbonyl group, a naphthyl group which is unsubstituted or substituted by one or more groups such as an alkyl or cycloalkyl group, an alkoxy group, a halogen, a nitro group, and a carbonyl group, a heteroaryl group which is unsubstituted or substituted by one or more groups such as an alkyl or cycloalkyl group, an alkoxy group, a halogen, a nitro group, and a carbonyl group. As examples of heteroaryl groups, mention may be made of pyridines, pyrroles and carbazoles. Alternatively, two of R¹, R² and R³ may form part of a ring, for example of a pyrrolidine, of a piperidine, of a morpholine, of a thiomorpholine, or of one of the higher homologs thereof. Still alternatively, two of R¹, R² and R³ may form part of several rings such as for example 1-azabicyclo[2.2.2]octane (or quinuclidine).

According to certain embodiments, R¹, R² and R³ may be identical.

According to other embodiments, R¹, R² and R³ may be different from one another.

According to certain embodiments, at least two of R¹, R² and R³ are identical.

According to certain embodiments, at least one of R¹, R² and R³ is a hydrogen.

According to other embodiments, none of R¹, R² and R³ is a hydrogen.

According to preferred embodiments, when the monoamine of formula (II) is a primary amine, it may be tert-butylamine or 3-methoxypropylamine.

According to preferred embodiments, when the monoamine of formula (II) is a secondary amine, it may be diisopropylamine or diethylamine, and preferably diisopropylamine.

According to preferred embodiments, when the monoamine of formula (II) is a tertiary amine, it may be triethylamine or diethylaniline.

According to other embodiments, the monoamine may be a polyetheramine, i.e. an amine comprising multiple ether functions.

According to preferred embodiments, the monoamine is a primary polyetheramine.

According to other embodiments, the monoamine is a secondary or tertiary polyetheramine.

Thus, in the case of a monoamine which is a polyetheramine, this can be of formula (III):

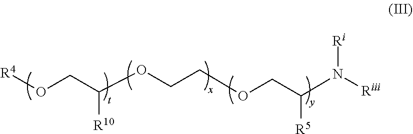

R⁴, R⁵ and R¹⁰ may independently represent a hydrogen atom or a group comprising from 1 to 10 carbon atoms. This group may be linear or branched and saturated or unsaturated. Preferably, R⁴, R⁵ and R¹⁰ independently represent a linear or branched group comprising from 1 to 10 carbon atoms, preferably from 1 to 7 carbon atoms and more preferably from 1 to 3 carbon atoms.

According to certain embodiments, R⁴ may be chosen from an alkyl group, a cycloalkyl group, an arylalkyl group, an aryl group, or an alkylaryl group, the alkyl, cycloalkyl, alkylaryl, arylalkyl and aryl groups being as described above.

Preferably, R⁴ is an alkyl group, preferably comprising from 1 to 7 carbon atoms, and preferably from 1 to 3 carbon atoms.

According to certain embodiments, R⁵ may be chosen from an alkyl group, a cycloalkyl group, or an aryl group, these groups being as described above. Preferably, R⁵ is an alkyl group, preferably comprising from 1 to 2 carbon atoms. More preferably, R⁵ is chosen from a methyl group and an ethyl group.

According to certain embodiments, R¹⁰ may be chosen from an alkyl group, a cycloalkyl group, or an aryl group, the alkyl, cycloalkyl and aryl groups being as described above. Preferably, R¹⁰ is an alkyl group, preferably comprising from 1 to 2 carbon atoms. More preferably, R¹⁰ is chosen from a methyl group and an ethyl group.

According to certain preferred embodiments, R⁴, R⁵ and R¹⁰ may be identical.

According to other embodiments, R⁴, R⁵ and R¹⁰ may be different from one another.

According to preferred embodiments, R⁵ and R¹⁰ are different from one another. For example, one of R⁵ and R¹⁰ may be an ethyl group and the other of R⁵ and R¹⁰ may be a methyl group.

According to preferred embodiments, at least one of R⁴, R⁵ and R¹⁰ is a methyl group.

Rⁱ and Rⁱⁱ may independently represent a hydrogen atom or a group comprising from 1 to 20 carbon atoms. This group may be linear or branched and saturated or unsaturated.

According to certain embodiments, Rⁱ and Rⁱⁱ may independently be chosen from an alkyl group, a cycloalkyl group, an aryl group, or an arylalkyl group. By way of example, Rⁱ and Rⁱⁱ may independently be a methyl group, an ethyl group, an n-propyl group, an isopropyl group, a cyclopropyl group, a tert-butyl group, an isobutyl group, an n-butyl group, a sec-butyl group, a cyclobutyl group, a cyclopentyl group, a cyclohexyl group, an alkyl group substituted by an aryl group such as an alkyl phenyl, a phenyl group which is unsubstituted or substituted by one or more groups such as an alkyl or cycloalkyl group, an alkoxy group, a halogen, a nitro group, and a carbonyl group, a naphthyl group which is unsubstituted or substituted by one or more groups such as an alkyl or cycloalkyl group, an alkoxy group, a halogen, a nitro group, and a carbonyl group, a heteroaryl group which is unsubstituted or substituted by one or more groups such as an alkyl or cycloalkyl group, an alkoxy group, a halogen, a nitro group, and a carbonyl group. As examples of heteroaryl groups, mention may be made of pyridines, pyrroles and carbazoles. Alternatively, Rⁱ and Rⁱⁱ may form part of a ring, for example of a pyrrolidine, of a piperidine, of a morpholine, of a thiomorpholine, or of one of the higher homologs thereof.

According to certain preferred embodiments, Rⁱ and Rⁱⁱ are both hydrogen atoms. In this case, it is a primary polyetheramine.

According to other embodiments, at least one of Rⁱ and Rⁱⁱ is a group comprising from 1 to 20 carbon atoms. In this case, it is a secondary polyetheramine.

According to other embodiments, both of Rⁱ and Rⁱⁱ are independently groups comprising from 1 to 20 carbon atoms. In this case, it is a tertiary polyetheramine.

According to certain embodiments, t, x and y may independently represent a number from 0 to 90, preferentially from 0 to 70, preferentially from 0 to 50, and even more preferentially from 0 to 30. Thus, t, x and y may independently represent a number from 0 to 10, or from 10 to 20; or from 20 to 30; or from 30 to 40; or from 40 to 50; or from 50 to 60; or from 60 to 70; or from 70 to 80; or from 80 to 90.

When t is other than 0, the number t represents the number of ethoxy groups substituted by a group R¹⁰ (preferably propoxy groups when R¹⁰ is methyl or butoxy groups when R¹⁰ is ethyl) present in the monoamine of formula (III).

The number t may or may not be an integer. For example, if a mixture of different alkylene oxides is used, t corresponds to the average degree of ethoxylation of the ethoxy groups substituted by a group R¹⁰ (preferably to the average degree of propoxylation when R¹⁰ is methyl or butoxylation when R¹⁰ is ethyl).

When x is other than 0, the number x represents the number of ethoxy groups present in the monoamine of formula (III).

The number x may or may not be an integer. For example, if a mixture of different alkylene oxides is used, x corresponds to the average degree of ethoxylation.

When y is other than 0, the number y represents the number of ethoxy groups substituted by a group R⁵ (preferably propoxy groups when R⁵ is methyl or butoxy groups when R⁵ is ethyl) present in the monoamine of formula (III).

The number y may or may not be an integer. For example, if a mixture of different alkylene oxides is used, y corresponds to the average degree of ethoxylation of the ethoxy groups substituted by a group R⁵ (preferably to the average degree of propoxylation when R⁵ is methyl or butoxylation when R⁵ is ethyl).

When t and y are other than 0, the sum t+y represents the number of ethoxy groups substituted by groups R⁵ and R¹⁰ (preferably propoxy groups when R⁵ and R¹⁰ are methyl or butoxy groups when R⁵ and R¹⁰ are ethyl) present in the amine of formula (Ill).

According to certain embodiments, when t is equal to 0, y is other than 0.

According to other embodiments, when y is equal to 0, t is other than 0.

According to yet other embodiments, in particular when R⁵ and R¹⁰ are different, t and y are both other than 0.

According to certain embodiments, when y and/or t is equal to 0, x is other than 0.

According to other embodiments, when x is equal to 0, y and/or t is other than 0.

The monoamines of formula (Ill) may have a molecular mass of 200 to 5500 g/mol, and preferably of 500 to 2500 g/mol. For example, the monoamines of formula (III) may have a molecular mass of 200 to 500 g/mol; or of 500 to 750 g/mol; or of 750 to 1000 g/mol; or of 1000 to 1250 g/mol; or of 1250 to 1500 g/mol; or of 1500 to 1750 g/mol; or of 1750 to 2000 g/mol; or of 2000 to 2250 g/mol; or of 2250 to 2500 g/mol; or of 2500 to 2750 g/mol; or of 2750 to 3000 g/mol; or of 3000 to 3250 g/mol; or of 3250 to 3500 g/mol; or of 3500 to 3750 g/mol; or of 3750 to 4000 g/mol; or of 4000 to 4250 g/mol; or of 4250 to 4500 g/mol; or of 4500 to 4750 g/mol; or of 4750 to 5000 g/mol; or of 5000 to 5250 g/mol; or of 5250 to 5500 g/mol.

This type of polyetheramines is for example sold under the name Jeffamine M series by the company Huntsman.

When the amine is a polyamine, it may be chosen from a primary and/or secondary and/or tertiary polyamine. Preferably, it is a primary polyamine, i.e. all of its amine groups are primary amine groups. More preferably, it is a diamine. However, polyamines comprising more than two amine groups (for example three or four) such as polyethyleneimines (PEIs) may be used.

According to certain embodiments, the polyamine can be of formula (IV):

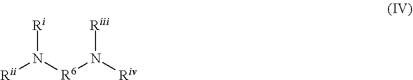

R⁶ may represent a divalent group comprising from 2 to 60 carbon atoms, preferably from 2 to 40 carbon atoms and more preferably from 2 to 15 carbon atoms.

R⁶ may be linear or branched, cyclic or alicyclic, and saturated or unsaturated.

R⁶ may comprise one or more heteroatoms such as an oxygen atom, a sulfur atom, a nitrogen atom or a halogen. Preferably, a single heteroatom may be present in R⁶.

In addition, R⁶ may be chosen from a divalent alkyl radical, a divalent cycloalkyl radical, a divalent alicyclic radical, a divalent arylalkyl radical or a divalent aryl radical. Preferably, R⁶ is an alkyl group.

Rⁱ and Rⁱⁱ are as detailed above.

Rⁱⁱⁱ an R^{iv} may independently represent a hydrogen atom or a group comprising from 1 to 20 carbon atoms. This group may be linear or branched and saturated or unsaturated.

According to certain embodiments, Rⁱⁱⁱ an R^{iv} may independently be chosen from an alkyl group, a cycloalkyl group, an aryl group, or an arylalkyl group. By way of example, Rⁱⁱⁱ an R^{iv} may independently be a methyl group, an ethyl group, an n-propyl group, an isopropyl group, a cyclopropyl group, a tert-butyl group, an isobutyl group, an n-butyl group, a sec-butyl group, a cyclobutyl group, a cyclopentyl group, a cyclohexyl group, an alkyl group substituted by an aryl group such as an alkyl phenyl, a phenyl group which is unsubstituted or substituted by one or more groups such as an alkyl or cycloalkyl group, an alkoxy group, a halogen, a nitro group, and a carbonyl group, a naphthyl group which is unsubstituted or substituted by one or more groups such as an alkyl or cycloalkyl group, an alkoxy group, a halogen, a nitro group, and a carbonyl group, a heteroaryl group which is unsubstituted or substituted by one or more groups such as an alkyl or cycloalkyl group, an alkoxy group, a halogen, a nitro group, and a carbonyl group. As examples of heteroaryl groups, mention may be made of pyridines, pyrroles and carbazoles. Alternatively, Rⁱⁱⁱ an R^{iv} may form part of a ring, for example of a pyrrolidine, of a piperidine, of a morpholine, of a thiomorpholine, or of one of the higher homologs thereof.

According to certain preferred embodiments, Rⁱ and Rⁱⁱ and/or Rⁱⁱⁱ and R^{iv} are all hydrogen atoms.

According to other embodiments, at least one of Rⁱ and Rⁱⁱ and/or at least one of Rⁱⁱⁱ an R^{iv} is a group comprising from 1 to 20 carbon atoms.

According to other embodiments, both of Rⁱ and Rⁱⁱ and/or both of Rⁱⁱⁱ and R^{iv} are independently groups comprising from 1 to 20 carbon atoms.

According to preferred embodiments, the polyamine of formula (IV) may be chosen from ethylenediamine, 1,3-propanediamine, 1,5-pentanediamine, 1,6-hexanediamine, 1,12-dodecanediamine, 2-methyl-1,5-pentanediamine, 3-methyl-1,5-pentanediamine, isophoronediamine, 4,4′-methylenedianiline, 2-methylbenzene-1,4-diamine, diethylenetriamine, 4,6-diethyl-2-methylbenzene-1,3-diamine, 4,4′-methylenedicyclohexanamine, 2,4,6-trimethyl-1,3-phenylenediamine, and naphthalene-1,8-diamine.

More preferably, the polyamine of formula (IV) may be chosen from ethylenediamine, 1,3-propanediamine and 1,6-hexanediamine, and preferably the polyamine of formula (IV) is 1,3-propanediamine or 1,6-hexanediamine.

According to other embodiments, the polyamine may be a polyetheramine comprising two amine groups, preferably primary amine groups. Alternatively, the polyamine may be a secondary or tertiary polyamine comprising two amine groups.

Thus, when it is a polyetheramine comprising two amine groups, it can be of formula (V):

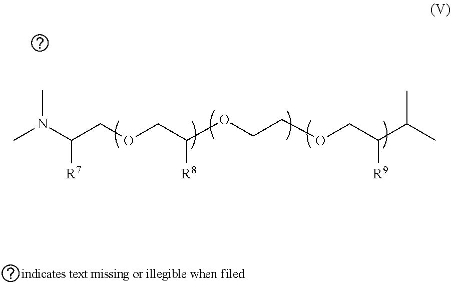

R⁷, R⁸ and R⁹ may independently represent a group comprising from 1 to 10 carbon atoms, preferably from 1 to 6 carbon atoms, and more preferably from 1 to 2 carbon atoms. These groups may be linear or branched and saturated or unsaturated.

R⁷, R⁸ and R⁹ may independently be chosen from an alkyl group, a cycloalkyl group, or an aryl group, these groups being as described above. Preferably, at least one of R⁷, R⁸ and R⁹ is an alkyl group, and more preferably a methyl group or an ethyl group.

According to certain preferred embodiments, R⁷, R⁹ and R⁹ may be identical.

According to other embodiments, R⁷, R⁹ and R⁹ may be different from one another.

According to preferred embodiments, at least one of R⁷, R⁹ and R⁹ is a methyl group, and preferably R⁷, R⁹ and R⁹ are methyl groups.

According to preferred embodiments, R⁹ and R⁹ are different from one another.

According to other embodiments, at least one of R⁹ and R⁹ is a methyl group, and the other of R⁹ and R⁹ is an ethyl group.

According to other embodiments, at least one of R⁹ and R⁹ is a methyl group, and the other of R⁹ and R⁹ is an ethyl group.

Rⁱ, Rⁱⁱ, Rⁱⁱⁱ and R^{iv} are as detailed above.

According to certain preferred embodiments, Rⁱ and Rⁱⁱ and/or Rⁱⁱⁱ and R^{iv} are all hydrogen atoms.

According to other embodiments, at least one of Rⁱ and Rⁱⁱ and/or at least one of Rⁱⁱⁱ an R^{iv} is a group comprising from 1 to 20 carbon atoms.

According to other embodiments, both of Rⁱ and Rⁱⁱ and/or both of Rⁱⁱⁱ and R^{iv} are independently groups comprising from 1 to 20 carbon atoms.

According to certain embodiments, v, w and z may independently represent a number from 0 to 90, preferentially from 0 to 70. Thus, v, w and z may independently represent a number from 0 to 10, or from 10 to 20; or from 20 to 30; or from 30 to 40; or from 40 to 50; or from 50 to 60; or from 60 to 70; or from 70 to 80; or from 80 to 90.

According to certain embodiments, z is equal to 0 and v is other than 0.

According to other embodiments, z is other than 0 and v is equal to 0.

According to yet other embodiments, z and v are both other than 0.

When z and v are other than 0, the sum z+v represents the number of substituted ethoxy groups (preferably propoxy or butoxy groups) present in the polyamine of formula (V).

The sum z+v may or may not be an integer. For example, if a mixture of different alkylene oxides is used, z+v corresponds to the average degree of ethoxylation of the ethoxy groups substituted by R⁹ and R⁹ (preferably to the degree of propoxylation or butoxylation).

When v is equal to 0, the number z represents the number of ethoxy groups substituted by R⁹ (preferably propoxy groups when R⁹ is methyl or butoxy groups when R⁹ is ethyl) present in the polyamine of formula (V).

When z is equal to 0, the number v represents the number of ethoxy groups substituted by R⁹ (preferably propoxy groups when R⁹ is methyl or butoxy groups when R⁹ is ethyl) present in the polyamine of formula (V).

The numbers z and v may or may not be integers.

The number w represents the number of ethoxy groups present in the polyamine.

The number w may or may not be an integer. For example, if a mixture of different molecules is used, w corresponds to the average degree of ethoxylation.

According to certain embodiments, v and w may be 0. This type of polyetheramines is for example sold under the names Jeffamine D series and Jeffamine SD series by the company Huntsman.

According to other embodiments, w may be equal to 0, while v is greater than 0.

According to other embodiments, v and w may be greater than 0. This type of polyetheramines is for example sold under the name Jeffamine ED series by the company Huntsman.

The polyetheramines of formula (V) may have a molecular mass of 100 to 5000 g/mol, preferably of 200 to 4000 g/mol, preferably of 200 to 2000 g/mol and preferably of 200 to 1000 g/mol. For example, the polyetheramines of formula (V) may have a molecular mass of 100 to 500 g/mol; or of 500 to 750 g/mol; or of 750 to 1000 g/mol; or of 1000 to 1250 g/mol; or of 1250 to 1500 g/mol; or of 1500 to 1750 g/mol; or of 1750 to 2000 g/mol; or of 2000 to 2250 g/mol; or of 2250 to 2500 g/mol; or of 2500 to 2750 g/mol; or of 2750 to 3000 g/mol; or of 3000 to 3250 g/mol; or of 3250 to 3500 g/mol; or of 3500 to 3750 g/mol; or of 3750 to 4000 g/mol; or of 4000 to 4250 g/mol; or of 4250 to 4500 g/mol; or of 4500 to 4750 g/mol; or of 4750 to 5000 g/mol.

According to other embodiments, the polyetheramine comprising two amine groups can be of formula (VI):

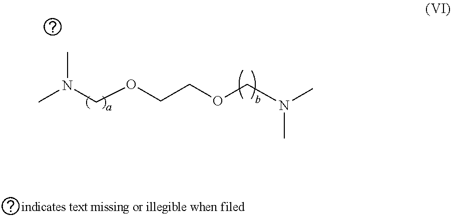

Rⁱ, Rⁱⁱ, Rⁱⁱⁱ and R^{iv} are as described above.

According to certain preferred embodiments, Rⁱ and Rⁱⁱ and/or Rⁱⁱⁱ and R^{iv} are all hydrogen atoms.

According to other embodiments, at least one of Rⁱ and Rⁱⁱ and/or at least one of Rⁱⁱⁱ an R^{iv} is a group comprising from 1 to 20 carbon atoms.

According to other embodiments, both of Rⁱ and Rⁱⁱ and/or both of Rⁱⁱⁱ and R^{iv} are independently groups comprising from 1 to 20 carbon atoms.

According to certain embodiments, a and b may independently represent a number from 1 to 20 and preferably from 2 to 11. According to certain preferred embodiments, a and b are identical. Preferably, a and b are equal to 2 or 3.

According to other embodiments, a and b are different. In this case, at least one of a and b is preferably equal to 2 or 3.

The polyetheramines of formula (VI) may have a molecular mass of 150 to 1500 g/mol, preferably of 150 to 1000 g/mol and preferably of 150 to 500 g/mol. For example, the polyetheramines of formula (VI) may have a molecular mass of 150 to 160 g/mol; or of 160 to 170 g/mol; or of 170 to 180 g/mol; or of 180 to 190 g/mol; or of 190 to 200 g/mol; or of 200 to 300 g/mol; or of 300 to 400 g/mol; or of 400 to 500 g/mol; or of 500 to 600 g/mol; or of 600 to 700 g/mol; or of 700 to 800 g/mol; or of 800 to 900 g/mol; or of 900 to 1000 g/mol; or of 1000 to 1100 g/mol; or of 1100 to 1200 g/mol; or of 1200 to 1300 g/mol; or of 1300 to 1400 g/mol; or of 1400 to 1500 g/mol.

This type of polyetheramines (formula (VI)) is for example sold under the name Jeffamine EDR series by the company Huntsman.

According to other embodiments, the polyamine may be a primary polyetheramine comprising three amine groups. Alternatively, the polyamine may be a secondary or tertiary polyamine comprising three amine groups.

Thus, when it is a polyetheramine comprising three amine groups, it can be of formula (VII):

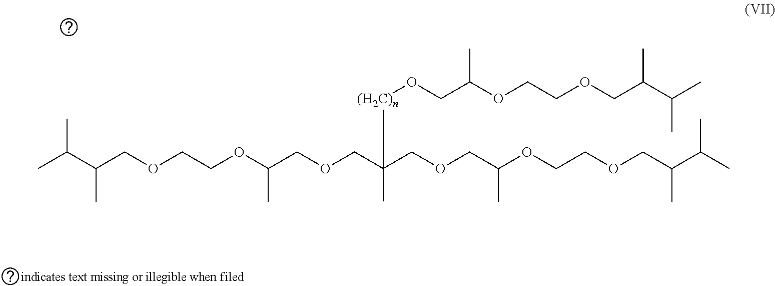

R₁⁸, R₁⁹, R₂⁸, R₂⁹, R₂⁹, R₃⁸, and R₃⁹ may independently represent a group comprising from 1 to 10 carbon atoms, preferably from 1 to 6 carbon atoms, and more preferably from 1 to 2 carbon atoms. These groups may be linear or branched and saturated or unsaturated.

R₁⁸, R₁⁹, R₂⁸, R₂⁹, R₂⁹, R₃⁸, and R₃⁹ may independently be chosen from an alkyl group, a cycloalkyl group, or an aryl group, these groups being as described above. Preferably, at least one of R₁⁸, R₁⁹, R₂⁸, R₂⁹, R₂⁹, R₃⁸, and R₃⁹ is an alkyl group. More preferably R₁⁸, R₁⁹, R₂⁸, R₂⁹, R₂⁹, R₃⁸, and R₃⁹ are chosen from a methyl group or an ethyl group.

According to certain preferred embodiments, R₁⁸, R₁⁹, R₂⁸, R₂⁹, R₂⁹, R₃⁸, and R₃⁹ may be identical, for example they are all a methyl group.

According to other embodiments, R₁⁸, R₁⁹, R₂⁸, R₂⁹, R₂⁹, R₃⁸, and R₃⁹ may be different from one another.

According to certain embodiments, R₁⁸ is different from R₂⁸ and/or R₃⁹.

According to certain embodiments, R₁⁹ is different from R₂⁹ and/or R₃⁹.

According to preferred embodiments, at least one of R₁⁸, R₁⁹ and/or at least one of R₂⁸, R₂⁹ and/or at least one of R₃⁸, R₃⁹ and/or is a methyl group and the other of R₁⁸, R₁⁹ and/or R₂⁸, R₂⁹ and/or R₃⁸, R₃⁹ and/or is an ethyl group.

R may represent a hydrogen atom or a group comprising from 1 to 10 carbon atoms, and preferably from 1 to 3 carbon atoms. This group may be linear or branched.

According to certain embodiments, R may be chosen from an alkyl group, a cycloalkyl group, or an aryl group, the alkyl, cycloalkyl, aryl or arylalkyl groups being as described above.

When R is a group comprising from 1 to 10 carbon atoms, it is preferably an alkyl group, preferably comprising from 1 to 3 carbon atoms, and preferably from 1 to 2 carbon atoms.

According to certain embodiments, R is a hydrogen atom.

According to other embodiments, R is an ethyl group.

Rⁱ, Rⁱⁱ, Rⁱⁱⁱ and R^{iv} are also as detailed above.

According to certain embodiments, z₁, z₂ and z₃ may represent a number from 0 to 80, and preferably from 0 to 70. For example, z₁, z₂ and z₃ may be from 0 to 5; or from 5 to 10; or from 10 to 15; or from 15 to 20; or from 20 to 25; or from 25 to 30; or from 30 to 35; or from 35 to 40; or from 40 to 45; or from 45 to 50; or from 50 to 55; or from 55 to 60; or from 60 to 65; or from 65 to 70; or from 70 to 75; or from 75 to 80. The numbers z₁, z₂ and z₃ may or may not be an integer.

According to certain embodiments, w₁, w₂ and w₃ may represent a number from 0 to 50, and preferably from 0 to 40. For example, w₁, w₂ and w₃ may be from 0 to 5; or from 5 to 10; or from 10 to 15; or from 15 to 20; or from 20 to 25; or from 25 to 30; or from 30 to 35; or from 35 to 40. The numbers w₁, w₂ and w₃ may or may not be an integer.

According to certain embodiments, v₁, v₂ and v₃ may represent a number from 0 to 20, and preferably from 0 to 10. For example, v₁, v₂ and v₃ may be from 0 to 2; or from 2 to 4; or from 4 to 6; or from 6 to 8; or from 8 to 10; or from 10 to 12; or from 12 to 14; or from 14 to 16; or from 16 to 18; or from 18 to 20. The numbers v₁, v₂ and v₃ may or may not be an integer.

According to certain embodiments, at least one of z₁, z₂ and z₃ is other than 0.

According to certain embodiments, at least one of v₁, v₂ and v₃ is other than 0.

According to other embodiments, at least one of z₁, z₂ and z₃ is other than 0 and v₁, v₂ and V3 are equal to 0.

According to certain embodiments, at least one of w₁, w₂ and w₃ is other than 0.

According to other embodiments, at least one of w₁, w₂ and w₃ is equal to 0, and preferably at least two of w₁, w₂ and w₃ and preferably all three of w₁, w₂ and w₃ are equal to 0.

According to certain embodiments, at least one of v₁ and z₁ is equal to 0 and/or at least one of v₂ and z₂ is equal to 0 and/or at least one of v₃ and z₃ is equal to 0.

According to preferred embodiments, at least one of v₁ and z₁ is equal to 0 and/or at least one of v₂ and z₂ is equal to 0 and/or at least one of v₃ and z₃ is equal to 0 and at least one of w₁, w₂ and w₃ is equal to 0, and preferably at least two of w₁, w₂ and w₃ and preferably all three of w₁, w₂ and w₃ are equal to 0.

The sum w₁+w₂+w₃ represents the number of ethoxy groups present in the polyamine of formula (VII).

The sum v₁+v₂+v₃+z₁+z₂+z₃ represents the number of ethoxy groups substituted by R₁⁸, R₁⁹, R₂⁸, R₂⁹, R₃⁸ and R₃⁹ (preferably propoxy or butoxy groups) present in the polyamine of formula (VII).

The sum v₁+v₂+v₃+z₁+z₂+z₃ may or may not be an integer. For example, if a mixture of different alkylene oxides is used, this sum corresponds to the average degree of ethoxylation of the ethoxy groups substituted by Rib, R₁⁹, R₂⁸, R₂⁹, R₃⁸ and R₃⁹ (preferably to the degree of propoxylation and/or butoxylation).

The sums z₁+z₂+z₃, v₁+v₂+v₃ and w₁+w₂+w₃ may independently represent a number from 0 to 90, preferentially from 0 to 70, preferentially from 0 to 50 and even more preferentially from 0 to 30. Thus, this number may be from 0 to 10; or from 10 to 20; or from 20 to 30; or from 30 to 40; or from 40 to 50; or from 50 to 60; or from 60 to 70; or from 70 to 80; or from 80 to 90.

According to certain embodiments, when w₁, w₂, w₃, z₁, z₂ and z₃ are equal to 0, v₁+v₂+v₃ may be from 2 to 90, and preferably from 4 to 90. For example, this sum may be from 2 to 5; or from 5 to 10; or from 10 to 20; or from 20 to 30; or from 30 to 40; or from 40 to 50; or from 50 to 60; or 60 or 70; or from 70 to 80; or 80 to 90.

The number n may represent a number from 0 to 30, preferably from 1 to 20, and more preferably from 1 to 10. For example, n may be from 0 to 5; or from 5 to 10; or from 10 to 15; or from 15 to 20; or from 20 to 25; or from 25 to 30.

According to certain preferred embodiments, n may be 0 or 1.

The polyetheramines of formula (VII) may have a molecular mass of 300 to 6000 g/mol, preferably of 300 to 5000 g/mol, preferably of 300 to 4000 g/mol and preferably of 300 to 3000 g/mol. For example, the polyetheramines of formula (VII) may have a molecular mass of 300 to 500 g/mol; or of 500 to 750 g/mol; or of 750 to 1000 g/mol; or of 1000 to 1250 g/mol; or of 1250 to 1500 g/mol; or of 1500 to 1750 g/mol; or of 1750 to 2000 g/mol; or of 2000 to 2250 g/mol; or of 2250 to 2500 g/mol; or of 2500 to 2750 g/mol; or of 2750 to 3000 g/mol; or of 3000 to 3250 g/mol; or of 3250 to 3500 g/mol; or of 3500 to 3750 g/mol; or of 3750 to 4000 g/mol; or of 4000 to 4250 g/mol; or of 4250 to 4500 g/mol; or of 4500 to 4750 g/mol; or of 4750 to 5000 g/mol; or of 5000 to 5250 g/mol; or of 5250 to 5500 g/mol; or of 5500 to 5750 g/mol; or of 5750 to 6000 g/mol.

This type of polyetheramines (formula (VII)) is for example sold under the names Jeffamine T series and Jeffamine ST series by the company Huntsman.

In all of the formulae above, the groups with indices t, x, y, v, w, z, vᵢ, wᵢ, and zᵢ, may or may not be adjacent in the molecule. For example, ethoxy groups may alternate randomly (according to a certain statistical distribution) with propoxy and/or butoxy groups along the same chain.

Alternatively, other types of polyamines that may be used in the context of the present invention are polyethyleneimines (or polyaziridines), that is to say a polymer comprising a repeating unit composed of the amine group and of the biradical “—CH₂CH₂—” group. These types of polyamines may be linear, branched or dendrimers. Examples include tetraethylenepentamine, EPOMIN SP012 and also the polyethyleneimines of the Lupasol® name (in particular Lupasol® FG) sold by the company BASF.

According to the invention, the organoborane can form a complex with the amine, with a molar ratio of organoborane to the amine of 0.1 to 10, and preferably of 0.5 to 5. Preferably, this ratio is from 0.5 to 2. This ratio may in particular be from 0.1 to 0.5; or from 0.5 to 1; or from 1 to 2; or from 2 to 4; or from 4 to 6; or from 6 to 8; or from 8 to 10. For example, when a monoamine is involved, this ratio is preferably approximately 1. However, when a diamine is involved, this ratio is preferably approximately 2.

According to certain preferred embodiments, the organoborane-amine complex may be chosen from triethylborane-1,3-propanediamine, tri-n-butylborane-3-methoxypropylamine, triethylborane-diethylenetriamine, tri-n-butylborane-1,3-propanediamine, tri-sec-butylborane-1,3-propanediamine and triethylborane-1,6-hexanediamine.

The organoborane-amine complex may be present in part A of the composition at a content by mass of 5% to 100%, preferably of 5% to 50%, and more preferably of 10% to 30%, relative to the total mass of part A of the composition. This content may in particular be from 5% to 10%; or from 10% to 15%; or from 15% to 20%; or from 20% to 25%; or from 25% to 30%; or from 30% to 35%; or from 35% to 40%; or from 40% to 45%; or from 45% to 50%; or from 50% to 55%; or from 55% to 60%; or from 60% to 65%; or from 65% to 70%; or from 70% to 75%; or from 75% to 80%; or from 80% to 85%; or from 85% to 90%; or from 90% to 95%; or from 95% to 100%.

More particularly, the content of organoborane-amine complex must be sufficient to allow a complete reaction. On the other hand, a high content of organoborane-amine complex risks leading to a rapid reaction, which would prevent effective mixing of part A with part B.

According to certain preferred embodiments, the organoborane-amine complex may be prepared before it is introduced into part A of the composition. This preparation may be effected, for example, by reacting an amine as described above with an organoborane compound under inert conditions.

The organoborane present in the organoborane-amine complex can initiate a radical polymerization after being activated, that is to say decomplexed from the amine.

Polymer with Acrylic Groups and Isocyanate Groups

The two-component composition, and more particularly part B of the two-component composition, comprises a polymer comprising at least one acrylic group and at least one isocyanate group. Preferably, the acrylic group is a methacrylic group. The term “polymer” is understood to mean a molecule consisting of the repetition of subunits or monomers.

An “isocyanate group” is understood to mean a group having the formula (VIII):

—N═C═O (VIII)

An “acrylic group” is understood to mean a group having the formula (IX):

—X—(C═O)—CH(R^{V})═CH₂ (IX)

R^{V} may represent a hydrogen atom or a methyl radical, and preferably a methyl radical, and X may represent —O— or —NR′^{N}—, with R′^{N} representing a hydrogen atom or a linear or branched alkyl radical comprising from 1 to 22 carbon atoms, preferably from 1 to 18, preferentially from 1 to 14 and even more advantageously from 1 to 8 carbon atoms. Preferably, X may represent —O—. Preferably, the acrylic group may be chosen from acrylic esters and acrylamides, and more preferably the acrylic group may be a methacrylic group chosen from methacrylic esters and methacrylamides.

According to certain embodiments, the isocyanate group(s) are present at the ends of the main chain of the polymer, and the acrylic group(s) are present in the form of side groups along the main chain and/or at the ends of the main chain of the polymer.

According to certain embodiments, the acrylic group(s) and the isocyanate group(s) are present at the ends of the polymer, that is to say at the ends of the main chain of the polymer.

The polymer comprising at least one acrylic group and at least one isocyanate group may have a number-average molecular mass (Mn) of 500 to 50 000 g/mol. For example, the number-average molecular mass (Mn) of the polymer may be from 500 to 1000 g/mol; 1000 to 2000 g/mol; or from 2000 to 3000 g/mol; or from 3000 to 4000 g/mol; or from 4000 to 5000 g/mol; or from 5000 to 6000 g/mol; or from 6000 to 7000 g/mol; or from 7000 to 8000 g/mol; or from 8000 to 9000 g/mol; or from 9000 to 10 000 g/mol; or from 10 000 to 15 000 g/mol; or from 15 000 to 20 000 g/mol; or from 20 000 to 25 000 g/mol; or from 25 000 to 30 000 g/mol; or from 30 000 to 35 000 g/mol; or from 35 000 to 40 000 g/mol; or from 40 000 to 45 000 g/mol; or from 45 000 to 50 000 g/mol. The number-average molecular mass can be measured by gel permeation chromatography (GPC).

According to preferred embodiments, the polymer is a polyurethane; thus the polyurethane comprises at least one acrylic group and at least one isocyanate group.

According to a first embodiment, this polyurethane may be obtained according to the two-step process described in application WO 2017/108531. Thus, this polyurethane may be obtained by reacting a hydroxylated polyether-acrylate, a hydroxylated polyester-acrylate or a hydroxylated polycarbonate-acrylate and at least one polyisocyanate.

According to a second embodiment, this polyurethane may be synthesized according to the two-step process described in document WO 2019/011784. Thus, this polyurethane may be obtained by reaction of a polyurethane comprising at least two —NCO end functions (preferably at the ends of the main chain) and of at least one compound chosen from a hydroxylated ester of acrylic or methacrylic acid or a hydroxylated amide of acrylic or methacrylic acid.

In the context of the invention, the term “hydroxylated ester of acrylic or methacrylic acid” is understood to mean an acrylic acid or methacrylic acid ester, the ester radical of which is substituted by at least one hydroxyl group. A hydroxylated ester of (meth)acrylic acid may, for example, be represented by the following formula:

CH₂═CR^{V}—C(═O)O—R^{O}

R^{V} may be as described above, and R^{O} may represent an organic radical substituted by at least one hydroxyl group.

According to certain embodiments, the hydroxylated ester of acrylic or methacrylic acid has the following formula (X):

CH₂═CR^{V}—C(═O)—O—R^{AC}—OH (X)

R^{V} may be as described above, and R^{AC} may represent a divalent linear or branched, aliphatic or cyclic, and saturated or unsaturated hydrocarbon radical. R^{AC} may preferably comprise from 2 to 240 carbon atoms, and/or may optionally be interrupted by one or more heteroatoms (such as for example N, O, or S, and in particular O), and/or may optionally be interrupted by one or more divalent groups —N(R″^{N})— with R″^{N} representing a linear or branched alkyl radical comprising from 1 to 22 carbon atoms (tertiary amines), —C(═O)O— (ester), —C(═O)NH— (amide), —NHC(═O)O— (carbamate), —NHC(═O)—NH— (urea), or —C(═O)— (carbonyl), and/or may optionally be substituted.

Preferably, the hydroxylated ester of acrylic or methacrylic acid has one of the following formulae:

CH₂═CR^{V}—C(═O)—O—R^{AC}—OH (X-1)

R^{V} may be as described above, and R^{AC1} may represent a divalent linear or branched, aliphatic or cyclic, and saturated or unsaturated hydrocarbon radical. R^{AC1} may comprise from 2 to 22 carbon atoms, preferably from 2 to 18, preferentially from 2 to 14, and even more advantageously from 2 to 6 carbon atoms.

CH₂═CR^{V}—C(═O)—O—R^{AC1}—O—[C(═O)—(CH₂)ᵣ—O]ₛ—H (X-2)

R^{V} and R^{AC1} may be as described above.

r may be an integer ranging from 1 to 10, preferably from 1 to 5, and preferentially r may be equal to 5.

s may be an integer ranging from 1 to 10, s preferably being equal to 2.

CH₂═CR^{V}—C(═O)—O—[R^{AC2}—O]ₚ—H (X-3)

R^{V} may be as described above.

R^{AC2} may represent a linear or branched divalent hydrocarbon radical comprising from 2 to 4 carbon atoms.

p may be an integer ranging from 2 to 120, preferably from 1 to 10, and preferably p may be equal to 2 or 3.

Mention may be made, among the hydroxylated esters of acrylic acid and methacrylic acid of formula (X-1), for example, of 2-hydroxyethyl acrylate (HEA), 2-hydroxypropyl acrylate (HPA), 2-hydroxybutyl acrylate (2-HBA) and 4-hydroxybutyl acrylate (4-HBA) sold by Sartomer, Cognis or BASF, 2-hydroxyethyl methacrylate (HEMA) and 2-hydroxypropyl methacrylate (HPMA) sold by Evonik, 2-hydroxybutyl methacrylate (2-HBMA) and 4-hydroxybutyl methacrylate (4-HBMA) sold by Sigma-Aldrich.

Mention may be made, among the hydroxylated esters of acrylic acid and methacrylic acid of formula (X-2) above, for example, of polycaprolactone acrylate SR 495B (CAPA) sold by Sartomer or hydroxyethylcaprolactone acrylate (HECLA) sold by BASF.

Mention may be made, among the ethoxylated and/or propoxylated derivatives of acrylic acid and methacrylic acid of abovementioned formula (X-3), for example, of Blemmer® AP-150, Blemmer® AP-200, Blemmer® AP-400, Blemmer® AP-550, Blemmer® AP-800, Blemmer® AP-1000, Blemmer® AE-90, Blemmer® AE-150, Blemmer® AE-200, Blemmer® AE-350 or Blemmer® AE-400, sold by Nippon Oil & Fats Corporation, or SR 604 sold by Sartomer.

Preferably, the hydroxylated ester of acrylic or methacrylic acid may be of formula (X-1) and more preferentially may be of one of the following formulae (X-1-1), (X-1-2), (X-1-3) or (X-1-4):

CH₂═CH—C(═O)—O—CH₂—CH₂—OH (X-1-1)

CH₂═C(CH₃)—C(═O)—O—CH₂—CH₂—OH (X-1-2)

CH₂═CH—C(═O)—O—CH₂—CH(CH₃)—OH (X-1-3)

CH₂═C(CH₃)—C(═O)—O—CH₂—CH(CH₃)—OH (X-1-4)

formula (X-1-1) being 2-hydroxyethyl acrylate, formula (X-1-2) being 2-hydroxyethyl methacrylate, formula (X-1-3) being 2-hydroxypropyl acrylate, and formula (X-1-4) being 2-hydroxypropyl methacrylate.

In the context of the invention, the term “hydroxylated amide of acrylic or methacrylic acid” is understood to mean an acrylic acid or methacrylic acid amide, the amide radical of which is substituted by at least one hydroxyl group. A hydroxylated amide of acrylic or methacrylic acid may, for example, be represented by the following formula:

CH₂═CR^{V}—C(═O)—N(R′^{N})—R^{N}

R^{V} and R′^{N} may be as described above.

R^{N} may represent an organic radical substituted by at least one hydroxyl group.

According to certain embodiments, the hydroxylated amide of acrylic acid has the following formula (XI):

CH₂═CR^{V}—C(═O)—N(R′^{N})—R^{AM}—OH

R^{V} and R′^{N} may be as described above.

R^{AM} may represent a linear or branched, aliphatic or cyclic, saturated or unsaturated, divalent hydrocarbon radical preferably comprising from 1 to 240 carbon atoms, and/or optionally being interrupted by one or more heteroatoms (such as, for example, N, O or S, and in particular O), and/or optionally being interrupted by one or more divalent —N(R″^{N})— groups with R″^{N} being as defined above, and/or optionally being substituted.

According to certain embodiments, the hydroxylated amide of acrylic or methacrylic acid has one of the following formulae:

CH₂═CR^{V}—C(═O)—N(R′^{N})—R^{AM1}—OH (XI-1)

R^{V} and R′^{N} may be as described above.

R^{AM1} may represent a linear or branched, aliphatic or cyclic, saturated or unsaturated, divalent hydrocarbon radical comprising from 1 to 22 carbon atoms, preferably from 1 to 18, preferentially from 1 to 14 and even more advantageously from 1 to 6 carbon atoms.

CH₂═CR^{V}—(═O)—N(R^{N})—R^{AM1}—O—[C(═O)—(CH₂)ᵣ—O]ₛ—H (XI-2)

R′^{N}, R^{V}, R^{AM1}, r, and s may be as defined above.

(XI-3) CH₂═CR^{V}—C(═O)—N(R^{N})—[R^{AM3}—O]ₚ—H (XI-3)

R^{V}, R′^{N} and p may be as defined above.

R^{AM3} may represent a linear or branched divalent alkylene radical comprising from 2 to 4 carbon atoms.

Preferably, the hydroxylated amide of acrylic or methacrylic acid can be of formula (XI-1) and more preferentially can be of one of the following formulae (XI-1-1), (XI-1-2), (XI-1-3) or (XI-1-4):

CH₂═CH—C(═O)—NH—CH₂—CH₂—OH (XI-1-1)

CH₂═C(CH₃)—C(═O)—N H—CH₂—CH₂—OH (XI-1-2)

CH₂═CH—C(═O)—NH—CH₂—CH(CH₃)—OH (XI-1-3)

CH₂═C(Me)-C(═O)—NH—CH₂—CH(CH₃)—OH (XI-1-4)

formula (XI-1-1) being (2-hydroxyethyl)acrylamide, formula (XI-1-2) being (2-hydroxyethyl)methacrylamide, formula (XI-1-3) being (2-hydroxypropyl)acrylamide, and formula (XI-1-4) being (2-hydroxypropyl)methacrylamide.

Alternatively, the hydroxylated ester or the hydroxylated amide may comprise more than one acrylic function, for example two acrylic functions (such as trimethylolpropane diacrylate), or three acrylic functions (such as pentaerythritol triacrylate sold by the company Sartomer under the name SR 444D), or four acrylic functions, or five acrylic functions (such as dipentaerythritol pentacrylate sold by the company Sartomer under the name SR 399).

Alternatively, the hydroxylated ester or the hydroxylated amide may comprise more than one hydroxyl function, for example two hydroxyl functions and two acrylic functions (such as pentaerythritol diacrylate available from BOC Sciences), or two hydroxyl functions and one acrylic function (such as glycerol monoacrylate available from BOC Sciences).

Preferably, the polyurethane comprising at least one acrylic group and at least one isocyanate group may be prepared by a process comprising the following steps:

E1) the preparation of a polyurethane comprising at least two NCO end functions (preferably at the ends of the main chain) by a polyaddition reaction:

i) of at least one polyisocyanate, preferably chosen from diisocyanates, triisocyanates, diisocyanate oligomers, and mixtures thereof;

ii) with at least one polyol, preferably chosen from polyether polyols, polyester polyols, polyene polyols, polycarbonate polyols, poly(ether-carbonate) polyols, polymers bearing —OH end groups, and mixtures thereof;

in amounts such that the NCO/OH molar ratio, denoted (r1), is strictly greater than 1, preferably ranges from 1.60 to 1.90 and preferentially ranges from 1.65 to 1.85;

and

E2) the reaction of the product formed on conclusion of step E1) with at least one hydroxylated ester of acrylic or methacrylic acid as defined above (preferably of formula (X-1-1) or (X-1-2)) or at least one hydroxylated amide of acrylic or methacrylic acid as defined above (preferably of formula (XI-1-1) or (XI-1-2)), in amounts such that the OH/NCO molar ratio, denoted (r2), less than 1.00, is defined so as to achieve the desired number of isocyanate functions and acrylic functions per mole of polymer.

Preferentially, step E2) is carried out with at least one hydroxylated ester of acrylic acid as defined above, preferably of the formula (X-1-1) or (X-1-2).

In the context of the invention, (r1) is the NCO/OH molar ratio corresponding to the molar ratio of the number of isocyanate (NCO) groups to the number of hydroxyl (OH) groups borne by all of the polyisocyanates and polyols present in the reaction medium of step E1).

When the polyurethane bearing NCO end groups is obtained during step E1) from a mixture of polyisocyanates or of several polyisocyanates added successively, the calculation of the ratio (r1) takes into account firstly the NCO groups borne by all of the polyisocyanates present in the reaction medium of step E1), and secondly the OH groups borne by the polyols present in the reaction medium of step E1).

In the context of the invention, (r2) is the OH/NCO molar ratio corresponding to the molar ratio of the number of hydroxyl (OH) groups to the number of isocyanate (NCO) groups borne respectively by all of the alcohols and of the isocyanates (as regards in particular the polyurethane bearing NCO end groups and optionally the polyisocyanates which have not reacted on conclusion of step E1)) present in the reaction medium of step E2).

The polyols used in step E1) of the invention may be chosen from those, the number-average molar mass (Mn) of which ranges from 400 to 12 000 g/mol, preferably from 1000 to 8000 g/mol and more preferentially from 1000 to 4000 g/mol.

Preferably, their hydroxyl functionality may range from 2 to 3, and preferentially is 2.

The polyols that can be used according to the invention may have a (mean) hydroxyl number (OHN) ranging from 9 to 420 milligrams of KOH per gram of polyol (mg KOH/g), preferably from 14 to 168 mg KOH/g and preferentially from 28 to 168 mg KOH/g.

According to certain embodiments, the hydroxyl number of polyols exhibiting a hydroxyl functionality of 2 may range from 9 to 280 mg KOH/g, preferentially from 14 to 112 mg KOH/g and more preferentially from 28 to 112 mg KOH/g.

According to certain embodiments, the hydroxyl number of polyols exhibiting a hydroxyl functionality of 3 ranges from 14 to 420 mg KOH/g, preferentially from 21 to 168 mg KOH/g, preferably from 15 to 56 mg KOH/g and more preferentially from 42 to 168 mg KOH/g.

The polyols which can be used may be chosen from polyether polyols, polyester polyols, polycaprolactone polyols, unsaturated or hydrogenated polyene polyols, polycarbonate polyols, poly(ether-carbonate) polyols, polymers bearing —OH end groups, and mixtures thereof.

The polyols which can be used may preferably be chosen from polyether polyols, polyester polyols, and mixtures thereof.

More preferentially, the polyether polyols which can be used according to the invention are chosen from polyoxyalkylene diols or polyoxyalkylene triols, the linear or branched alkylene portion of which comprises from 1 to 4 carbon atoms, more preferentially from 2 to 3 carbon atoms.

Even more preferentially, the polyester polyols which can be used according to the invention are preferably chosen from aliphatic, aromatic, arylaliphatic polyester diols and triols, and mixtures thereof.

Mention may be made, as examples of polyoxyalkylene polyols which can be used according to the invention, of polyoxypropylene diols or triols (also denoted by polypropylene glycol (PPG) diols or triols) having a number-average molecular mass (Mn) ranging from 400 to 12 000 g/mol, and mixtures thereof.

The abovementioned polyether polyols may be prepared conventionally and are widely available commercially. They may be obtained by polymerization of the corresponding alkylene oxide in the presence of a basic catalyst (for example potassium hydroxide) or of a catalyst based on a double metal/cyanide complex.

Mention may be made, as example of polyether diol, of the polyoxypropylene diol sold under the name Acclaim® by Bayer, such as Acclaim® 12200, with a number-average molar mass in the vicinity of 11 335 g/mol and the hydroxyl number of which ranges from 9 to 11 mg KOH/g, Acclaim® 8200, with a number-average molar mass in the vicinity of 8057 g/mol and the hydroxyl number of which ranges from 13 to 15 mg KOH/g, and Acclaim® 4200, with a number-average molar mass in the vicinity of 4020 g/mol and the hydroxyl number of which ranges from 26.5 to 29.5 mg KOH/g, which are obtained, in a known way, by polymerization of the corresponding alkylene oxide in the presence of a catalyst based on a double metal/cyanide complex.

Mention may be made, as example of polyether triol, of the polyoxypropylene triol sold under the name Voranol® CP3355 by Dow, the hydroxyl number of which is 48 mg KOH/g.

According to the invention, the polyester polyols may have a number-average molecular mass (Mn) ranging from 400 to 12 000 g/mol, preferably from 1000 to 8000 g/mol and more preferentially from 1000 to 4000 g/mol.

Mention may be made, as examples of polyester diols or triols, of the polyester polyols of natural origin derived from castor oil and also the polyester polyols resulting from the polycondensation:

of one or more aliphatic (linear, branched or cyclic) or aromatic polyols, such as, for example, monoethylene glycol, diethylene glycol, 1,2-propanediol, 1,3-propanediol, 1,4-butanediol, butenediol, 1,6-hexanediol, cyclohexanedimethanol, tricyclodecanedimethanol, neopentyl glycol, cyclohexanedimethanol, glycerol, trimethylolpropane, 1,2,6-hexanetriol, sucrose, glucose, sorbitol, pentaerythritol, mannitol, N-methyldiethanolamine, triethanolamine, a fatty alcohol dimer, a fatty alcohol trimer, and mixtures thereof, with

one or more polycarboxylic acids or an ester or anhydride derivative thereof, such as 1,6-hexanedioic acid (adipic acid), dodecanedioic acid, azelaic acid, sebacic acid, adipic acid, 1,18-octadecanedioic acid, phthalic acid, isophthalic acid, terephthalic acid, succinic acid, a fatty acid dimer, a fatty acid trimer and the mixtures of these acids, an unsaturated anhydride, such as, for example, maleic or phthalic anhydride, or a lactone, such as, for example, caprolactone.

The abovementioned polyester polyols may be prepared conventionally and are for the most part commercially available.

Mention may be made, as examples of polyester polyols, for example, of the following products with a hydroxyl functionality equal to 2:

estolide polyols resulting from the polycondensation of one or more hydroxy acids, such as ricinoleic acid, with a diol (mention may be made, for example, of Polycin® D-2000 with a number-average molecular mass (Mn) of approximately 2000 g/mol, Polycin® D-3000 with a number-average molecular mass (Mn) of approximately 3000 g/mol and Polycin® D-4000 with a number-average molecular mass (Mn) of approximately 4000 g/mol, which are available from Vertellus),

Tone® 0240 (sold by Union Carbide), which is a polycaprolactone with a number-average molecular mass (Mn) of approximately 2000 g/mol and a melting point of approximately 50° C.,

Dynacoll® 7381 (sold by Evonik) with a number-average molecular mass (Mn) of approximately 3500 g/mol and having a melting point of approximately 65° C.,

Dynacoll® 7360 (sold by Evonik), which results from the condensation of adipic acid with hexanediol and has a number-average molecular mass (Mn) of approximately 3500 g/mol and a melting point of approximately 55° C.,

Dynacoll® 7330 (sold by Evonik) with a number-average molecular mass (Mn) of approximately 3500 g/mol and having a melting point of approximately 85° C.,

Dynacoll® 7363 (sold by Evonik), which also results from the condensation of adipic acid with hexanediol and has a number-average molecular mass (Mn) of approximately 5500 g/mol and a melting point of approximately 57° C.,

Dynacoll® 7250 (sold by Evonik): polyester polyol having a viscosity of 180 Pa·s at 23° C., a number-average molecular mass (Mn) equal to 5500 g/mol and a Tg equal to −50° C.,

Kuraray® P-6010 (sold by Kuraray): polyester polyol having a viscosity of 68 Pa·s at 23° C., a number-average molecular mass (Mn) equal to 6000 g/mol and a Tg equal to −64° C.,

Kuraray® P-10010 (sold by Kuraray): polyester polyol having a viscosity of 687 Pa·s at 23° C. and a number-average molecular mass (Mn) equal to 10 000 g/mol.

According to the invention, the polyene polyols, and also their corresponding hydrogenated or epoxidized derivatives, may have a number-average molecular mass (Mn) ranging from 400 to 12 000 g/mol, preferably from 1000 to 8000 g/mol and more preferentially from 1000 to 4000 g/mol.

Preferably, the polyene polyols which can be used according to the invention are chosen from butadiene and/or isoprene homopolymers and copolymers comprising hydroxyl end groups, which are optionally hydrogenated or epoxidized.

In the context of the invention, the term “hydroxyl end groups” of a polyene polyol is understood to mean the hydroxyl groups located at the ends of the main chain of the polyene polyol.

The abovementioned hydrogenated derivatives may be obtained by complete or partial hydrogenation of the double bonds of a polydiene comprising hydroxyl end groups, and are thus saturated or unsaturated.

The abovementioned epoxidized derivatives may be obtained by chemoselective epoxidation of the double bonds of the main chain of a polyene comprising hydroxyl end groups, and thus comprise at least one epoxy group in their main chain.

Mention may be made, as examples of polyene polyols, of saturated or unsaturated butadiene and/or isoprene homopolymers and copolymers comprising hydroxyl end groups, which are optionally epoxidized, such as, for example, those sold under the name Poly BD® or Krasol® by Cray Valley.

Mention may be made, as examples of polyene polyols, of:

saturated or unsaturated butadiene homopolymer diols comprising hydroxyl end groups, such as those sold under the name Poly BD® R45HT (Mn=2800 g/mol) or Krasol® (Mn=2400 to 3100 g/mol) by Cray Valley,

saturated or unsaturated isoprene homopolymer diols comprising hydroxyl end groups, such as, for example, those sold under the name Poly IP™ (unsaturated, Mn=2000 g/mol) or Epol™ (saturated, Mn=2600 g/mol) by Idemitsu Kosan.

According to the invention, the polycarbonate polyols may have a number-average molecular mass (Mn) ranging from 400 to 12 000 g/mol, preferably from 1000 to 8000 g/mol and more preferentially from 1000 to 4000 g/mol.

Mention may be made, as examples of polycarbonate diols, of:

Converge® Polyol 212-20 sold by Novomer, with a number-average molecular mass (Mn) equal to 2000 g/mol, the hydroxyl number of which is respectively 56 mg KOH/g,

Polyol C-2090 and C-3090, sold by Kuraray, with a number-average molecular mass (Mn) respectively of 2000 and 3000 g/mol and with a hydroxyl number of 56 and 37 mg KOH/g.

The hydroxyl number here represents the number of hydroxyl functions per gram of polyol and is expressed in the text of the present patent application in the form of the equivalent number of milligrams of potassium hydroxide (KOH) which are used in the quantitative determination of the hydroxyl functions.

According to the invention, the polymers bearing —OH end groups may be obtained by polyaddition reaction between one or more polyols and one or more polyisocyanates, in amounts of polyisocyanates and of polyols resulting in an NCO/OH molar ratio strictly of greater than 1. The reaction can be carried out in the presence of a catalyst. The polyols and polyisocyanates which can be used may be those typically used in the preparation of polyurethanes bearing —NCO end groups and preferably those described in the present patent application.

Preferably, the polyols are polyether polyols.

According to a preferred embodiment, step E1) is carried out in the presence of a diol having a number-average molecular mass (Mn) of greater than or equal to 400 g/mol, or in the presence of a mixture of polyols comprising one or more diols, the number-average molecular mass (Mn) of which is greater than or equal to 400 g/mol. More preferably still, all the diols used necessarily have a number-average molecular mass (Mn) of greater than or equal to 400 g/mol.

According to a preferred embodiment, step E1) is carried out:

with a single diol with a number-average molecular mass (Mn) of greater than or equal to 400 g/mol; or

with a mixture of a diol with a number-average molecular mass (Mn) of greater than or equal to 400 g/mol and of a triol advantageously having a number-average molecular mass (Mn) of greater than or equal to 400 g/mol.

The polyisocyanates which may be used according to the invention in step E1) may be added sequentially or reacted in the form of a mixture.

According to one embodiment, the polyisocyanates which may be used are diisocyanates, preferably chosen from the group consisting of isophorone diisocyanate (IPDI), hexamethylene diisocyanate (HDI), heptane diisocyanate, octane diisocyanate, nonane diisocyanate, decane diisocyanate, undecane diisocyanate, dodecane diisocyanate, 4,4′-methylenebis(cyclohexyl isocyanate) (4,4′-HMDI), norbornane diisocyanate, norbornene diisocyanate, cyclohexane-1,4-diisocyanate (CHDI), methylcyclohexane diisocyanate, ethylcyclohexane diisocyanate, propylcyclohexane diisocyanate, methyldiethylcyclohexane diisocyanate, cyclohexanedimethylene diisocyanate, 1,5-diisocyanato-2-methylpentane (MPDI), 1,6-diisocyanato-2,4,4-trimethylhexane, 1,6-diisocyanato-2,2,4-trimethylhexane (TMDI), 4-(isocyanatomethyl)octane-1,8-diisocyanate (TIN), 2,5-bis(isocyanatomethyl)bicyclo[2.2.1]heptane (2,5-NBDI), 2,6-bis(isocyanatomethyl)bicyclo[2.2.1]heptane (2,6-NBDI), 1,3-bis(isocyanatomethyl)cyclohexane (1,3-H6-XDI), 1,4-bis(isocyanatomethyl)cyclohexane (1,4-H6-XDI), xylylene diisocyanate (XDI) (especially m-xylylene diisocyanate (m-XDI)), toluene diisocyanate (especially toluene-2,4-diisocyanate (2,4-TDI) and/or toluene-2,6-diisocyanate (2,6-TDI)), diphenylmethane diisocyanate (especially diphenylmethane-4,4′-diisocyanate (4,4′-MDI) and/or diphenylmethane-2,4′-diisocyanate (2,4′-MDI)), tetramethylxylylene diisocyanate (TMXDI) (especially tetramethyl-meta-xylylene diisocyanate), an HDI allophanate, for example having the following formula (Y):

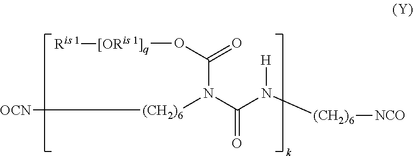

k may be an integer ranging from 1 to 2.

q may be an integer ranging from 0 to 9, and preferably from 2 to 5.

R^{is1} may represent a saturated or unsaturated, cyclic or acyclic, linear or branched hydrocarbon-based chain comprising from 1 to 20 carbon atoms, preferably from 1 to 12 carbon atoms, and more preferably from 6 to 14 carbon atoms.

R^{is2} may represent a linear or branched divalent alkylene group having from 2 to 4 carbon atoms, and preferably a divalent propylene group.

Preferably, the allophanate of formula (Y) is such that k, q, R^{is1} and R^{is2} are chosen such that the above HDI allophanate derivative comprises a content of isocyanate NCO groups ranging from 12% to 14% by weight, relative to the weight of said derivative.

The polyisocyanates which can be used to prepare the polyurethane used according to the invention are widely available commercially. Mention may be made, by way of example, of Scuranate® TX sold by Vencorex, corresponding to a 2,4-TDI with a purity of the order of 95%, Scuranate® T100 sold by Vencorex, corresponding to a 2,4-TDI with a purity of greater than 99% by weight, Desmodur® I sold by Covestro, corresponding to an IPDI, Takenate TM 500 sold by Mitsui Chemicals, corresponding to an m-XDI, Takenate TM 600 sold by Mitsui Chemicals, corresponding to an m-H6XD1, Vestanat® H12MD1 sold by Evonik, corresponding to an H12MD1, Desmodur N3300 and Desmodur N3600 sold by Covestro, corresponding to HDI oligomers, or also those of the Tolonate® series sold by Vencorex, such as Tolonate® X FLO 100, corresponding to an HDI allophanate derivative of formula (Y).

According to a preferred embodiment, the polyisocyanate(s) of step E1) is (are) chosen from the group consisting of toluene diisocyanate (especially the 2,4-TDI isomer, the 2,6-TDI isomer or mixtures thereof), meta-xylylene diisocyanate (m-XDI), isophorone diisocyanate, HDI allophanates, HDI oligomers, and mixtures thereof.

The reaction between said polyisocyanates and said polyols may be carried out at a reaction temperature T1 of less than 95° C. and preferably ranging from 65° C. to 80° C.

The polyaddition reaction of step E1) may be performed in the presence or absence of at least one reaction catalyst.

The reaction catalyst which can be used during the polyaddition reaction of step E1) may be any catalyst known to a person skilled in the art for catalyzing the formation of polyurethane by reaction of at least one polyisocyanate with at least one polyol. An amount ranging up to 0.3% by weight of catalysts, relative to the weight of the reaction medium of step E1), may be used. In particular, it is preferable to use from 0.02% to 0.2% by weight of catalysts, relative to the total weight of the reaction medium of step E1).

The polyurethane obtained at the end of the aforementioned step E1) may have the following formula (XII):

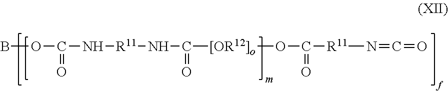

B may represent one of the two formulae below:

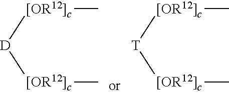

D and T may represent a saturated or unsaturated, aliphatic or cyclic, linear or branched, hydrocarbon radical comprising from 2 to 66 carbon atoms, optionally comprising one or more heteroatoms.

R¹¹ may represent a divalent group resulting from the polyisocyanates.

R¹² may represent a divalent group resulting from the polyols.

c may be a non-zero integer such that the number-average molar mass (Mn) of the polyol blocks of formula —[OR¹²]_{c}— ranges from 400 to 12 000 g/mol, preferably from 1000 to 8000 g/mol and more preferentially from 1000 to 4000 g/mol.

f may represent the mean functionality of the —NCO-terminated polyurethane, which is an integer or non-integer which may range from 2.0 to 2.2.

f, o and m are integers such that the NCO percentage of the polyurethane ranges from 0.4% to 30% and preferentially from 0.6% to 20%, relative to the total weight of said polyurethane.

In particular, R¹¹ may represent a divalent group chosen from one of the following aliphatic or aromatic divalent groups:

the divalent group derived from isophorone diisocyanate (IPDI):

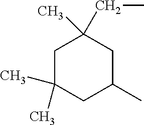

the divalent group derived from toluene-2,4-diisocyanate (2,4-TDI):

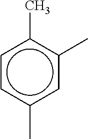

the divalent group derived from m-xylylene diisocyanate (m-XDI):

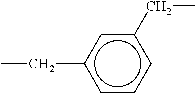

the divalent group derived from diphenylmethane-4,4′-diisocyanate (4,4′-MDI) and diphenylmethane-2,4′-diisocyanate (2,4′-MDI):

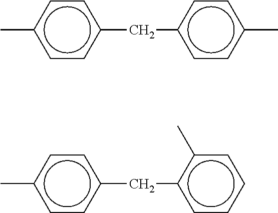

the divalent group derived from a hexamethylene diisocyanate (HDI) allophanate of following formula:

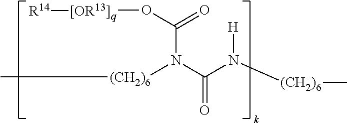

in which k may be an integer ranging from 1 to 2 and q may be an integer ranging from 2 to 5.

In this formula, R¹³ may represent a divalent propylene group and R¹⁴ may represent a saturated or unsaturated, cyclic or aliphatic, linear or branched hydrocarbon chain comprising from 6 to 14 carbon atoms.

k, q, R¹³ and R¹⁴ may be chosen such that the corresponding HDI allophanate derivative of formula (IX) comprises a content of isocyanate NCO groups ranging from 12% to 14% by weight.

The polyurethane obtained in step E1) preferably has a viscosity ranging from 5000 to 200 000 mPa·s (millipascal.second) at 23° C. and more preferentially a viscosity of less than 100 000 mPa·s.

According to certain preferred embodiments, the polyurethane comprising at least two NCO end functions is obtained by polyaddition reaction E1):

i) of at least one diisocyanate chosen from the group consisting of toluene diisocyanate, meta-xylylene, isophorone diisocyanate, HDI allophanates, and mixtures thereof;

ii) with at least one polyether diol having a number-average molecular mass (Mn) of greater than or equal to 400 g/mol, or with a mixture of polyether diol having a number-average molecular mass (Mn) of greater than or equal to 400 g/mol with a polyether triol advantageously having a number-average molecular mass (Mn) of greater than or equal to 400 g/mol.

The reaction of step E2) may be carried out at a reaction temperature T2 of less than 95° C. and preferably ranging from 65° C. to 80° C., preferably under anhydrous conditions.

The hydroxylated esters of acrylic or methacrylic acids of abovementioned formula (X), preferably of formula (X-1) or (X-2) or (X-3), may be employed either pure or in the form of a mixture of different hydroxylated esters of acrylic or methacrylic acid having a mean hydroxyl number of said mixture ranging from 56 to 483 mg KOH/g of said mixture.

The hydroxylated amides of acrylic or methacrylic acids of abovementioned formula (XI), preferably of formula (XI-1) or (XI-2) or (XI-3), may be employed either pure or in the form of a mixture of different hydroxylated amides of acrylic or methacrylic acid having a mean hydroxyl number of said mixture ranging from 56 to 487 mg KOH/g of said mixture.

Step E2) is preferably carried out with at least one hydroxylated ester of acrylic or methacrylic acid of abovementioned formula (X), preferably of abovementioned formula (X-1) or (X-2) or (X-3), and in particular of abovementioned formula (X-1-1), (X-1-2), (X-1-3) or (X-1-4), advantageously of abovementioned formula (X-1-1) or (X-1-2).

The reaction catalyst which can be used for steps E1) and E2) may be any catalyst known to a person skilled in the art for catalyzing the formation of polyurethane by reaction of at least one diisocyanate, of at least one polyol and of at least one hydroxyalkyl acrylate or methacrylate or one hydroxyalkylacrylamide or -methacrylamide.

Preferably, use is made of one or more catalysts chosen from catalysts not exhibiting or exhibiting very little risk of toxicity. In particular, the reaction catalyst(s) are chosen from the group consisting:

of organometallic derivatives of bismuth, such as bismuth neodecanoate, sold under the name Borchi Kat® 315 by OM Group, or bismuth carboxylate, sold under the name K-Kat® XC B221 by King Industries,

of organometallic derivatives of tin other than dibutyltin dilaurate, such as, for example, dioctyltin dilaurate (DOTL), such as sold under the name Tib® Kat 217 by TIB Chemicals,

of organometallic derivatives of zinc, such as zinc carboxylate, sold under the name Borchi Kat® 22 by OM Group,

of organometallic derivatives of titanium, such as titanium tetrabutoxide Ti(OCH₂CH₂CH₂CH₃)4 or titanium ethyl acetoacetate, sold under the name Tyzor® Pita by DuPont,

of organometallic derivatives of zirconium, such as the zirconium chelate sold under the name K-Kat® A209, zirconium acetylacetonate (Zr(acac)₄) and zirconium tetraethoxide Zr(OCH₂CH₃)₄, and

of mixtures thereof.

An amount ranging up to 0.3% by weight of catalysts, relative to the total weight of the reaction medium of step E2), may be used. In particular, it is preferable to use from 0.02% to 0.3% by weight of catalysts, relative to the total weight of the reaction medium of step E2).

According to a preferred embodiment, the abovementioned polyurethane (a) is obtained by a process comprising the following steps:

E1) the preparation of a polyurethane comprising at least two NCO end functions by polyaddition reaction:

i) of at least one diisocyanate chosen from the group consisting of toluene diisocyanate, meta-xylylene, isophorone diisocyanate, HDI allophanates, and mixtures thereof;

ii) with at least one polyether diol having a number-average molecular mass (Mn) of greater than or equal to 400 g/mol, or with a mixture of polyether diol having a number-average molecular mass (Mn) of greater than or equal to 400 g/mol with a polyether triol advantageously having a number-average molecular mass (Mn) of greater than or equal to 400 g/mol;

E2) the reaction of the product formed on conclusion of step E1) with at least one hydroxylated ester of acrylic or methacrylic acid of formula (X-1-1), in amounts such that the OH/NCO molar ratio (denoted r2) is less than or equal to 1.00.

A preferred polyurethane comprising acrylic groups and isocyanate groups is, for example, CN9303 sold by Sartomer.

According to other embodiments, the polymer comprising acrylic groups and isocyanate groups may be a polyacrylate and preferably a polymethacrylate comprising acrylic groups and isocyanate groups.

The monomers used to synthesize the polyacrylate may be acrylic and methacrylic monomers such as acrylic acid, methacrylic acid, acrylamide, methacrylamide, acrylonitrile, methacrylonitrile, acrylate and methacrylate. For example, these monomers may be chosen from acrylic acid, methacrylic acid, alkylacrylic monomers, alkylmethacrylic monomers and mixtures thereof, the alkyl group preferably having from 1 to 22 carbon atoms, and being linear, branched or cyclic; and the alkyl group preferably having from 1 to 12 carbon atoms, and being linear, branched or cyclic. Thus, this polymer (already comprising an acrylate end) may have a group, such as a hydroxyl group for example, capable of reacting with an isocyanate, preferably a polyisocyanate, to form the polymer according to the invention.

According to yet other embodiments, the polymer may be a polyester. In this case, the polyester may be synthesized by polycondensation of one or more polyhydric alcohols which preferably comprise from 2 to 15 carbon atoms with polycarboxylic acids which preferably comprise from 2 to 14 carbon atoms. The resulting polyester polyols may then be esterified in the presence of an unsaturated carboxylic acid monomer such as methacrylic or acrylic acid. In addition, one or more hydroxyl groups of the polyols can react with a polyisocyanate such as a diisocyanate to form the polymer according to the invention.

The polymer comprising at least one acrylic group and at least one isocyanate group may comprise from 0.5 to 4 acrylic groups per mole of polymer and preferably from 1 to 2.5 acrylic groups per mole of polymer. For example, it may comprise from 0.5 to 1; or from 1 to 1.5; or from 1.5 to 2; or from 2 to 2.5; or from 2.5 to 3; or from 3 to 3.5; or from 3.5 to 4 acrylic groups per mole of said polymer.

The polymer comprising at least one acrylic group and at least one isocyanate group may also comprise from 0.5 to 3 isocyanate groups per mole of polymer and preferably from 1 to 2.5 isocyanate groups per mole of polymer. For example, it may comprise from 0.5 to 1; or from 1 to 1.5; or from 1.5 to 2; or from 2 to 2.5; or from 2.5 to 3 isocyanate groups per mole of said polymer.

The isocyanate groups are distributed statistically at the end of the polymer chain. Certain individual molecules may possibly be devoid of an acrylic group and/or of an isocyanate group.

The acrylic groups are distributed statistically at the end of the chain and/or in the middle of the chain of the polymer.

In addition, this polymer may have a viscosity of 5000 to 100 000 mPa·s at 23° C. This viscosity can be measured with a Brookfield viscometer at 23° C.

The polymer comprising at least one acrylic group and at least one isocyanate group may be present in part B of the composition at a content by mass of 1% to 70% and preferably of 1% to 40%, relative to the total of part B of the composition. Thus, this content may be from 1% to 5%; or from 5% to 10%; or from 10% to 15%; or from 15% to 20%; or from 20% to 25%; or from 25% to 30%; or from 30% to 35%; or from 35% to 40%; or from 40% to 45%; or from 45% to 50%; or from 50% to 55%; or from 55% to 60%; or from 60% to 65%; or from 65% to 70%.

According to the present invention, the polymer comprising acrylic groups and isocyanate groups can act both as a decomplexing agent for releasing the organoborane from the organoborane-amine complex (with its isocyanate group) and also as a radically polymerizable compound after its polymerization initiated by the organoborane (with the acrylic group). Thus, during the crosslinking of the composition, a single homogeneous polymer network is advantageously created.

### Two-Component Composition

The two-component composition may also comprise at least one acrylic monomer or oligomer, and preferably at least one methacrylic monomer or oligomer. The polymerization of this compound is carried out by a radical route, that is to say by a chain polymerization which involves radicals as active species. Thus, in the case where an acrylic monomer or oligomer is present in the composition, this compound (monomer or oligomer) can copolymerize with the polymer comprising acrylic groups and isocyanate groups.

This acrylic monomer or oligomer may be present in at least one of the two parts (A and B) of the composition.

According to certain embodiments, the acrylic monomer or oligomer is present only in part A of the composition.

According to other preferred embodiments, the acrylic monomer or oligomer is present only in part B of the composition.

According to yet other embodiments, the acrylic monomer or oligomer is present in part A and also in part B of the composition.

The acrylic monomer or oligomer may be chosen from an acrylic acid, an acrylic ester, an acrylamide and an acrylonitrile. It may also be chosen from alkylacrylic monomers or oligomers and mixtures thereof, the alkyl group preferably having from 1 to 22 carbon atoms, and being linear, branched or cyclic; and the alkyl group preferably having from 1 to 12 carbon atoms, and being linear, branched or cyclic. Preferably, the acrylic monomer or oligomer is a methacrylic monomer or oligomer, that is to say chosen from a methacrylic acid, a methacrylic ester, a methacrylamide, a methacrylonitrile, and the alkylmethacrylic monomers or oligomers of mixtures thereof.

Advantageously, the radically polymerizable compound may be chosen from alkyl and cycloalkyl acrylates and methacrylates such as acrylic acid, methyl acrylate, ethyl acrylate, n-propyl acrylate, isopropyl acrylate, allyl acrylate, n-butyl acrylate, isobutyl acrylate, tert-butyl acrylate, n-hexyl acrylate, n-octyl acrylate, isooctyl acrylate (SR440 sold by Sartomer), 2-ethylhexyl acrylate, n-decyl acrylate, isodecyl acrylate (SR395 sold by Sartomer), lauryl acrylate (SR335 sold by Sartomer), tridecyl acrylate (SR489 sold by Sartomer), C12-C14 alkyl acrylate (SR336 sold by Sartomer), n-octadecyl acrylate (SR484 sold by Sartomer), C16-C18 alkyl acrylate (SR257C sold by Sartomer), cyclohexyl acrylate, tert-butylcyclohexyl acrylate (SR217 sold by Sartomer), 3,3,5-trimethylcyclohexyl acrylate (SR420 sold by Sartomer), isobornyl acrylate (SR506D sold by Sartomer), methacrylic acid, methyl methacrylate, ethyl methacrylate, n-propyl methacrylate, allyl methacrylate, isopropyl methacrylate, n-butyl methacrylate, isobutyl methacrylate, tert-butyl methacrylate, cyclohexyl methacrylate, n-hexyl methacrylate, n-octyl methacrylate, isooctyl methacrylate, 2-ethylhexyl methacrylate, isobornyl methacrylate, n-decyl methacrylate, isodecyl methacrylate, n-dodecyl methacrylate, tridecyl methacrylate, and mixtures thereof. Particularly preferred compounds are methyl acrylate, ethyl acrylate, butyl acrylate, 2-ethylhexyl acrylate, methyl methacrylate, ethyl methacrylate, butyl methacrylate and 2-ethylhexyl methacrylate.

In addition, the radically polymerizable compound may be chosen from acrylates and methacrylates comprising heteroatoms, that is to say acrylates and methacrylates which contain at least one atom which is not a carbon or hydrogen in the group of the alcohol part of the ester (without taking into account the atoms of the ester group itself). Preferably, the atom is an oxygen. Thus, the radically polymerizable compound may be chosen from tetrahydrofurfuryl acrylate (SR285 sold by Sartomer), tetrahydrofurfuryl methacrylate (SR203H sold by Sartomer), glycidyl acrylate, 2-hydroxyethyl acrylate, 2- and 3-hydroxypropyl acrylate, 2-methoxyethyl acrylate, 2-ethoxyethyl acrylate, 2- and 3-ethoxypropyl acrylate, 2-(2-ethoxyethoxy)ethyl acrylate (SR256 sold by Sartomer), methoxypolyethylene glycol acrylate (preferably comprising 2 to 8 (ethoxy) repeating units), polyethylene glycol acrylate (preferably comprising 2 to 8 (ethoxy) repeating units), polypropylene glycol acrylate (preferably comprising 2 to 8 (propoxy) repeating units), polycaprolactone acrylate (SR495B sold by Sartomer), 2-phenoxyethyl acrylate (SR339C sold by Sartomer), 2-[2-[2-(2-phenoxyethoxy)ethoxy]ethoxy]ethyl acrylate (SR410 sold by Sartomer), 2-[2-[2-(2-nonylphenoxyethoxy)ethoxy]ethoxy]ethyl acrylate (SR504D sold by Sartomer), cyclic trimethylolpropane formal acrylate (SR531 sold by Sartomer), cyclic glycerol formal acrylate, 2-[2-[2-(2-dodecyloxyethoxy)ethoxy]ethoxy]ethyl acrylate (SR9075 sold by Sartomer), glycidyl methacrylate, 2-hydroxyethyl methacrylate, 2- and 3-hydroxypropyl methacrylate, 2-methoxyethyl methacrylate, 2-ethoxyethyl methacrylate, 2- and 3-ethoxypropyl methacrylate, 2-(2-ethoxyethoxy)ethyl methacrylate, methoxypolyethylene glycol methacrylate (preferably comprising 2 to 8 (ethoxy) repeating units), polyethylene glycol methacrylate (preferably comprising 2 to 8 (ethoxy) repeating units), polypropylene glycol methacrylate (preferably comprising 2 to 8 (propoxy) repeating units), cyclic trimethylolpropane formal methacrylate, cyclic glycerol formal methacrylate (Visiomer® Glyfoma sold by Evonik), and mixtures thereof. Acrylates and methacrylates of ethylene glycol, diethylene glycol, trimethylpropane, triethylene glycol, tetraethylene glycol, dipropylene glycol, tripropylene glycol, tetrapropylene glycol, and pentapropylene may also be used. Particularly preferred compounds are 2-hydroxyethyl acrylate, 2-hydroxypropyl acrylate, polycaprolactone acrylate, 2-hydroxyethyl methacrylate, 2-hydroxypropyl methacrylate and polycaprolactone methacrylate. Diacrylate and dimethacrylate compounds may also be used within the context of this invention. Such compounds include ethylene glycol diacrylate, 1,3-butylene glycol diacrylate, 1,4-butanediol diacrylate, 1,6-hexanediol diacrylate (SR238 sold by Sartomer), 3-methyl-1,5-pentanediol diacrylate (SR341 sold by Sartomer), cyclohexanedimethanol diacrylate, neopentyl glycol diacrylate, 1,10-decanediol diacrylate (SR595 sold by Sartomer), tricyclodecanedimethanol diacrylate (SR833S sold by Sartomer), esterdiol diacrylate (SR606A sold by Sartomer), alkoxylated aliphatic diacrylates such as diethylene glycol diacrylate, triethylene glycol diacrylate (SR272 sold by Sartomer), dipropylene glycol diacrylate (SR508 sold by Sartomer), tripropylene glycol diacrylate (SR306 sold by Sartomer), tetraethylene glycol diacrylate (SR268G sold by Sartomer), ethoxylated and/or propoxylated cyclohexanedimethanol diacrylates, ethoxylated and/or propoxylated hexanediol diacrylates, ethoxylated and/or propoxylated neopentyl glycol diacrylates, caprolactone-modified neopentyl glycol hydroxypivalate diacrylate, dipropylene glycol diacrylate, ethoxylated (3) bisphenol A diacrylate (SR349 sold by Sartomer), ethoxylated (10) bisphenol A diacrylate (SR602 sold by Sartomer), ethoxylated (30) bisphenol A diacrylate, ethoxylated (40) bisphenol A diacrylate, polyethylene glycol (200) diacrylate (SR259 sold by Sartomer), polyethylene glycol (400) diacrylate (SR344 sold by Sartomer), polyethylene glycol (600) diacrylate (SR610 sold by Sartomer), propoxylated neopentyl glycol diacrylates, ethylene glycol dimethacrylate, 1,3-butylene glycol dimethacrylate, 1,4-butanediol dimethacrylate, 1,6-hexanediol dimethacrylate, 3-methyl-1,5-pentanediol dimethacrylate, 1,6-hexanediol monoacrylate monomethacrylate, cyclohexanedimethanol dimethacrylate, neopentyl glycol dimethacrylate, tricyclodecanedimethanol dimethacrylate, alkoxylated aliphatic methacrylates such as triethylene glycol dimethacrylate, tripropylene glycol dimethacrylate, tetraethylene glycol dimethacrylate, ethoxylated and/or propoxylated cyclohexanedimethanol dimethacrylates, ethoxylated and/or propoxylated hexanediol dimethacrylates, ethoxylated and/or propoxylated neopentyl glycol dimethacrylates, caprolactone-modified neopentyl glycol hydroxypivalate dimethacrylate, diethylene glycol dimethacrylate, dipropylene glycol dimethacrylate, tripropylene glycol dimethacrylate, ethoxylated (10) bisphenol A dimethacrylate, ethoxylated (3) bisphenol A dimethacrylate, ethoxylated (30) bisphenol A dimethacrylate, ethoxylated (40) bisphenol A dimethacrylate, polyethylene glycol (200) dimethacrylate, polyethylene glycol (400) dimethacrylate, polyethylene glycol (600) dimethacrylate, ethoxylated and/or propoxylated neopentyl glycol dimethacrylates, and mixtures thereof.

Triacrylate and trimethacrylate compounds may also be used within the context of this invention. Such compounds include glycerol trimethacrylate, glycerol triacrylate, ethoxylated and/or propoxylated glycerol triacrylates, trimethylolpropane triacrylate (SR351 sold by Sartomer), ethoxylated and/or propoxylated trimethylolpropane triacrylates, pentaerythritol triacrylate (SR444D sold by Sartomer), ethoxylated and/or propoxylated trimethylolpropane triacrylates, trimethylolpropane trimethacrylate, and tris(2-hydroxyethyl)isocyanurate triacrylate (SR368 sold by Sartomer), tris(2-hydroxyethyl)isocyanurate trimethacrylate, ethoxylated and/or propoxylated glycerol trimethacrylates, ethoxylated and/or propoxylated trimethylolpropane trimethacrylates, and pentaerythritol trimethacrylate.

Compounds comprising more than three acrylate or methacrylate groups may also be used such as, for example, pentaerythritol tetraacrylate (SR295 sold by Sartomer), ditrimethylolpropane tetraacrylate (SR355 sold by Sartomer), dipentaerythritol pentaacrylate (SR399 sold by Sartomer), ethoxylated and/or propoxylated pentaerythritol tetraacrylates, pentaerythritol tetramethacrylate, ditrimethylolpropane tetramethacrylate, dipentaerythritol pentamethacrylate and ethoxylated and/or propoxylated pentaerythritol tetramethacrylates.

In addition, the acrylic monomer or oligomer may be chosen from polymerizable methacrylic and acrylic oligomers such as urethane methacrylates and acrylates, polyester methacrylates and acrylates, polybutadiene methacrylate and acrylate and epoxy methacrylates and acrylates. Preferred compounds in this category are for example CN1963, CN1964, CN992, CN982, CN9002, CN9012, CN9200, CN964A85, CN965, CN966H90, CN991, CN9245S, 0N998B80, CN9210, CN9276, CN9209, PRO21596, CN9014NS, CN9800, CN9400, CN9167, CN9170A86, CN9761 and CN9165A, sold by Sartomer.

Acrylic monomers or oligomers which may be used within the context of the invention may also include acrylamide and methacrylamide monomers. For example, these monomers may be chosen from acrylamide, methacrylamide, N-(hydroxymethyl)acrylamide, N-(hydroxyethyl)acrylamide, N-(isobutoxymethyl)acrylamide, N-(3-methoxypropyl)acrylamide, N-[tris(hydroxymethyl)methyl]acrylamide, N-isopropylacrylamide, N-[3-(dimethylamino)propyl]methacrylamide, diacetone acrylamide, N,N′-methylenedimethacrylamide, N,N′-methylenediacrylamide, N,N′-(1,2-dihydroxyethylene)bismethacrylamide and N,N′-(1,2-dihydroxyethylene)bisacrylamide and also from the acrylamides and methacrylamides formed after reaction of acrylic or methacrylic acid (or of the acyl chloride of this acid) with primary and/or secondary amines such as 1,3-diaminopropane, N,N′-dimethyl-1,3-diaminopropane, 1,4-diaminobutane, polyamidoamines and polyoxyalkylenepolyamines.

According to certain embodiments, a single acrylic monomer or oligomer is present in part A and/or part B of the composition.

According to other embodiments, several acrylic monomers or oligomers are present in part A and/or part B of the composition.

The acrylic monomer(s) or oligomer(s) may be present in part A and/or part B of the composition at a content by mass of 0.01% to 70%, preferably from 1% to 60%, and more preferably from 25% to 60%, relative to the total mass of part A and/or part B of the composition. This content may for example be from 0.01% to 1%; or from 1% to 5%; or from 5% to 10%; or from 10% to 15%; or from 15% to 20%; or from 20% to 25%; or from 25% to 30%; or from 30% to 35%; or from 35% to 40%; or from 40% to 45%; or from 45% to 50%; or from 50% to 55%; or from 55% to 60%; or from 60% to 65%; or from 65% to 70%.

The two-component composition, and more particularly part B of the composition, may comprise a decomplexing agent, that is to say a compound—other than the polymer comprising acrylic groups and isocyanate groups—which is capable of reacting with the amine present in the organoborane-amine complex in order to release the organoborane.

This presence of a decomplexing agent (which is additional relative to the polymer comprising acrylic groups and isocyanate groups) is optional.

In the context of the present invention, the decomplexing agent may be chosen from an isocyanate, a Lewis acid, a carboxylic acid, a mineral acid, a phosphonic acid, a sulfonic acid, an acyl chloride, an anhydride, an aldehyde, a 1,3-dicarbonyl compound, and an epoxide. Preferably, the decomplexing agent is an isocyanate.

Compounds derived from diisocyanates such as biurets, uretdiones, isocyanurates, allophanates and oligomeric diisocyanates may also be used as decomplexing agent in the context of the present invention.

Thus, the isocyanate used in the context of the present invention may include any compound comprising at least one and preferably at least two isocyanate groups (polyisocyanate).

By way of example, the two-component composition, and more particularly part B of the composition, may comprise one or more isocyanate compounds chosen from alkylene diisocyanates, cycloalkylene diisocyanates, and aromatic and aliphatic-aromatic diisocyanates.

Specific examples of such types of isocyanate may include ethylene-1,2-diisocyanate, propylene-1,3-diisocyanate, butylene-1,4-diisocyanate, pentamethylene-1,5-diisocyanate (PDI), hexamethylene-1,6-diisocyanate (HDI), toluene-2,4-diisocyanate (2,4-TDI), toluene-2,6-diisocyanate (2,6-TDI), cyclopentylene-1,3-diisocyanate, cyclohexylene-1,4-diisocyanate, cyclohexylene-1,2-diisocyanate, isophorone diisocyanate (IPDI), diphenylmethane-4,4′-diisocyanate (4,4′-MDI), diphenylmethane-2,4′-diisocyanate (2,4′-MDI), diphenylmethane-2,2′-diisocyanate (2,2′-MDI), diphenylpropane-4,4′-diisocyanate (DPDI), m-xylylene diisocyanate (m-XDI), tetramethylxylylene diisocyanate (TMXDI), naphthylene-1,4-diisocyanate, naphthylene-1,5-diisocyanate, m-phenylene diisocyanate (MPDI), p-phenylene diisocyanate (PPDI), diphenylsulfone-4,4′-diisocyanate, furfurylene diisocyanate, 4,4′,4″-triisocyanatotriphenylmethane, benzene-1,3,5-triisocyanate, HDI isocyanurate, TDI isocyanurate, m-XDI isocyanurate, IPDI isocyanurate (VESTANAT® T1890/100 sold by Evonik), an HDI allophanate (Tolonate X FLO 100 sold by Vencorex), HDI biuret, HDI uretdione (Desmodur N 3400 sold by Covestro), glycerol/TDI adduct, TDI/trimethylolpropane adduct, m-XDI/glycerol adduct, m-XDI/trimethylolpropane adduct (Takenate® D-110N sold by Mitsui Chemicals, m-H6XD1/trimethylolpropane adduct (Takenate® D-120N sold by Mitsui Chemicals.

Preferably, the isocyanate compound used as decomplexing agent may be a prepolymer having at least one isocyanate end obtained for example after the reaction of an isocyanate compound as described above with a polyol or a polyamine. One such type of prepolymer is CN9303 sold by Sartomer.

The prepolymer may in particular be a polyurethane.

When the decomplexing agent is a Lewis acid, it may for example be chosen from tin chloride or titanium chloride.

When the decomplexing agent is a carboxylic acid, it may for example be chosen from acrylic acid, methacrylic acid, formic acid, acetic acid, 2-ethylhexanoic acid, lauric acid, benzoic acid, and p-methoxybenzoic acid, or from dicarboxylic acids such as oxalic acid, malonic acid, succinic acid, glutaric acid, maleic acid, adipic acid, phthalic acid, fumaric acid, glycolic acid, thioglycolic acid, lactic acid, isophthalic acid and terephthalic acid.

When the decomplexing agent is a mineral acid, it may for example be chosen from hydrochloric acid (HCl), sulfuric acid (H₂SO₄), phosphoric acid (H₃PO₄), phosphorous acid (H₃PO₃), hypophosphorous acid (H₃PO₂) and silicic acid.

When the decomplexing agent is a phosphonic acid, it may for example be chosen from vinylphosphonic acid, phenylphosphonic acid, methylphosphonic acid and octadecylphosphonic acid.

When the decomplexing agent is a sulfonic acid, it may for example be chosen from methanesulfonic acid and benzenesulfonic acid.

When the decomplexing agent is an anhydride, it may for example be chosen from acetic anhydride, propionic anhydride, acrylic anhydride, methacrylic anhydride, hexanoic anhydride, decanoic anhydride, lauric anhydride, benzoic anhydride, maleic anhydride, succinic anhydride, methylsuccinic anhydride, 2-octen-1-ylsuccinic anhydride, 2-dodecen-1-ylsuccinic anhydride, dodecenylsuccinic anhydride, cyclohexanedicarboxylic anhydride, phthalic anhydride, trimellitic anhydride and pyromellitic anhydride.

When the decomplexing agent is an aldehyde, it may for example be chosen from benzaldehyde, o-, m- and p-nitrobenzaldehyde, 2,4-dichlorobenzaldehyde, p-tolylaldehyde and 3-methoxy-4-hydroxybenzaldehyde. Acetals and dialdehydes may also be used.

When the decomplexing agent is a 1,3-dicarbonyl compound, it may for example be chosen from methyl acetoacetate, ethyl acetoacetate, tert-butyl acetoacetate, 2-methacryloyloxyethyl acetoacetate, diethylene glycol bis(acetoacetate), polycaprolactone tris(acetoacetate), polypropylene glycol bis(acetoacetate), poly(styrene-co-allyl acetoacetate), N,N-dimethylacetoacetamide, N-methylacetoacetamide, acetoacetanilide, ethylenebis(acetoacetamide), polypropylene glycol bis(acetoacetamide), acetoacetamide and acetoacetonitrile.

The decomplexing agent may be present in part B of the composition at a content by mass of 0.01% to 70%, and preferably of 0.1% to 60%, relative to the total mass of part B of the composition. Thus, the content of decomplexing agent in part B may in particular be from 0.01% to 0.1%; or from 0.1% to 1%; or from 1% to 5%; or from 5% to 10%; or from 10% to 15%; or from 15% to 20%; or from 20% to 25%; or from 25% to 30%; or from 30% to 35%; or from 35% to 40%; or from 40% to 45%; or from 45% to 50%; or from 50% to 55%; or from 55% to 60%; or from 60% to 65%; or from 65% to 70%.

The two-component composition may also comprise at least one additional amine, the additional amine being as defined above.

Preferably, the additional amine is present in part A of the composition. The presence of the amine (in excess relative to the organoborane) makes it possible to avoid premature decomplexation of the organoborane, and thus to stabilize the organoborane-amine complex (and hence part A of the composition) so as to increase its storage life.

According to certain embodiments, this additional amine is the same as the amine present in the organoborane-amine complex.

According to other embodiments, this additional amine is different from the amine present in the organoborane-amine complex.

According to certain embodiments, a single additional amine is present in the two-component composition.

According to other embodiments, two or more than two additional amines are present in the two-component composition.

According to preferred embodiments, it is a polyetheramine.

The additional amine may be present in the two-component composition, and preferably in part A of the composition, at a content by mass of 0.01% to 30%, and preferably of 0.01% to 25%, relative to the total mass of the composition and preferably relative to the total mass of part A of the composition. This content may be in particular from 0.01% to 0.5%; or from 0.5% to 1%; or from 1% to 5%; or from 5% to 10%; or from 10% to 15%; or from 15% to 20%; or from 20% to 25%; or from 25% to 30%.

The two-component composition may also comprise one or more additives chosen from fillers, plasticizers, tackifying resins, solvents, UV stabilizers, moisture absorbers, fluorescent materials and rheological additives.

Such additives may be present in one of the two parts of the composition, or alternatively in both parts of the composition.

For example, part A of the two-component composition may comprise fillers, plasticizers, tackifying resins, solvents, UV stabilizers, moisture absorbers, optical brighteners and rheological additives.

Part B of the two-component composition may for example comprise fillers and plasticizers.

The fillers may be chosen from talc, mica, kaolin, bentonite, aluminum oxides, titanium oxides, iron oxides, barium sulfate, hornblende, amphiboles, chrysotile, carbon black, carbon fibers, fumed or pyrogenic silicas, molecular sieves, calcium carbonate, wollastonite, glass beads, glass fibers, and combinations thereof.

As regards the plasticizer, this may be chosen from those known to a person skilled in the art in the coating or adhesive industries. Mention may be made, for example, of plasticizers based on phthalate, polyol ester (such as, for example, pentaerythritol tetravalerate, sold by Perstorp), epoxidized oil, esters of alkylsulfonic acid (such as, for example, Mesamoll sold by Lanxess), esters of 1,2-cyclohexanedicarboxylic acid (such as, for example, Hexamoll® DINCH sold by BASF) and mixtures thereof.

The tackifying resin may in particular be chosen from: resins obtained by polymerization of terpene hydrocarbons and of phenols, in the presence of Friedel-Crafts catalysts, such as the Dertophene® 1510 resin available from DRT having a molar mass of approximately 870 Da, Dertophene® H150 available from the same company with a molar mass equal to approximately 630 Da, Sylvarez® TP 95 available from Arizona Chemical having a molar mass of approximately 1200 Da; resins obtained by a process comprising the polymerization of α-methylstyrene such as the Norsolene® W100 resin available from Cray Valley, which is obtained by polymerization of α-methylstyrene without the action of phenols, with a number-average molar mass of 900 Da, Sylvarez® 510 which is also available from Arizona Chemical with a molar mass of approximately 1740 Da, the process for the production of which also comprises the addition of phenols; natural-origin or modified rosins, and derivatives thereof which are hydrogenated, dimerized, polymerized or esterified with monoalcohols or polyols such as the Sylvalite® RE 100 resin which is an ester of rosin and of pentaerythritol available from Arizona Chemical and has a molar mass of approximately 1700 Da; resins obtained by hydrogenation, polymerization or copolymerization of mixtures of unsaturated aliphatic hydrocarbons having approximately 5, 9 or 10 carbon atoms obtained from petroleum fractions; terpene resins; copolymers based on natural terpenes; and acrylic resins having a viscosity at 100° C. of less than 100 Pa·s.

The solvent may be a solvent which is volatile at ambient temperature (temperature of the order of 23° C.). The volatile solvent may, for example, be chosen from alcohols which are volatile at ambient temperature, such as ethanol or isopropanol. The volatile solvent makes it possible, for example, to reduce the viscosity of the two-component composition (of part A and/or of part B) and make the composition easier to apply. The volatile character of the solvent makes it possible for the product, obtained after crosslinking the composition, to no longer contain solvent.

The UV stabilizers may be chosen from benzotriazoles, benzophenones, “hindered” amines, such as bis(2,2,6,6-tetramethyl-4-piperidyl) sebacate, and mixtures thereof. Mention may be made, for example, of the products Tinuvin® 328 or Tinuvin™ 770, sold by BASF. The optical brightener may be for example 2,5-thiophenediylbis(5-tert-butyl-1,3-benzoxazole) such as Uvitex® OB sold by BASF.

As regards the rheological additives, these may be chosen from those known to a person skilled in the art in the coating or adhesive industries. Mention may be made, for example, of silica (in particular pyrogenic silica), or a micronized amide wax (such as, for example, the Crayvallac series sold by Arkema).

The additives may be present in the two-component composition at a content by mass of 0.01% to 80%, relative to the total mass of the composition. Thus, the additives may in particular be present in the two-component composition at a content by mass of 0.01% to 0.05%; or of 0.05% to 0.1%; or of 0.1% to 0.5%; or of 0.5% to 1%; or of 1% to 1.5%; or of 1.5% to 2%; or of 2% to 2.5%; or of 2.5% to 3%; or of 3% to 3.5%; or of 3.5% to 4%; or of 4% to 4.5%; or of 4.5% to 5%; or of 5% to 5.5%; or of 5.5% to 6%; or of 6% to 6.5%; or of 6.5% to 7%; or of 7% to 7.5%; or of 7.5% to 8%; or of 8% to 8.5%; or of 8.5% to 9%; or of 9% to 9.5%; or of 9.5% to 10%; or of 10% to 15%; or of 15% to 20%; or of 20% to 25%; or of 25% to 30%; or of 30% to 35%; or of 35% to 40%; or of 40% to 45%; or of 45% to 50%; or of 50% to 55%; or of 55% to 60%; or of 60% to 65%; or of 65% to 70%; or of 70% to 75%; or of 75% to 80%.

Parts A and B of the two-component composition may preferably remain separate until the composition is used. Thus, the decomplexation of the organoborane and the initiation of the polymerization commence when part A of the composition comes into contact with part B.

The mass ratio of part A of the composition to part B may be from 0.05 to 10, and preferably from 0.1 to 1. Thus, the mass ratio of part A of the composition to part B may be from 0.05 to 0.1; or from 0.1 to 0.5; or from 0.5 to 0.8; or from 0.8 to 1; or from 1 to 1.2; or from 1.2 to 2; or from 2 to 3; or from 3 to 4; or from 4 to 5; or from 5 to 6; or from 6 to 7; or from 7 to 8; or from 8 to 9; or from 9 to 10.

The two-component composition may have a ratio of amine groups (present in the organoborane-amine complex) to isocyanate groups (present in the polymer comprising acrylic groups and isocyanate groups and in the decomplexing agent when the latter is present) of greater than 1. Preferably this ratio is from 1 to 2, and more preferably from 1.25 to 2. Advantageously, a ratio of amine groups to isocyanate groups of greater than 1 makes it possible to obtain maximum adhesion given that in this case all of the organoborane will be activated by reaction of the isocyanate with the amine of the organoborane-amine complex.

### Use of the Composition

The two-component composition according to the invention can be used for the treatment of substrates having a low surface energy. More particularly, the two-component composition according to the invention can be used for the treatment of substrates having a surface energy of less than or equal to 45 mJ/m², preferably of less than or equal to 40 mJ/m², and more preferably of less than or equal to 35 mJ/m². For example, this surface energy may be from 10 to 15 mJ/m²; or from 15 to 20 mJ/m²; or 20 to 25 mJ/m²; or from 25 to 30 mJ/m²; or 30 to 35 mJ/m²; or from 35 to 40 mJ/m²; or from 40 to 45 mJ/m². Substrates exhibiting a low surface energy are, for example, polyolefins such as polyethylene, polypropylene, polybutadiene, polyisoprene, poly(vinylidene fluoride), polytetrafluoroethylene, and also the copolymers thereof. These surface energy values are well known in the prior art.

According to certain embodiments, part A of the composition can be mixed with part B, before coating of the two-component composition (mixture of parts A and B) on the surface of a substrate. Thus, the decomplexation of the organoborane and the initiation of polymerization commence when the two parts are mixed.

Part A can be mixed with part B at a temperature of 15 to 40° C., and preferably of 20 to 25° C.

The coating of the two-component composition on the surface of the substrate can then be carried out at a temperature of 15 to 40° C., and preferably of 20 to 25° C.

According to other embodiments, one of the two parts A and B of the composition can be coated on the surface of the substrate in a first stage, and in a second stage the second of the two parts can be coated on the surface of the substrate above the first of the two parts. Thus, the decomplexation of the organoborane and the initiation of the polymerization commence when the second of parts A and B of the composition is coated on the surface of the substrate.

The coating of the first of the two parts of the two-component composition on the surface of the substrate can be carried out at a temperature of 15 to 40° C., and preferably of 20 to 25° C.

The coating of the second of the two parts of the two-component composition on the surface of the substrate can then be carried out at a temperature of 15 to 40° C., and preferably of 20 to 25° C.

According to certain embodiments, in a first stage part A is coated on the surface of the substrate, and then in a second stage part B is coated above part A on the surface of the substrate.

According to other embodiments, in a first stage part A is coated on the surface of the substrate, and then in a second stage part B is coated above part A on the surface of the substrate.

Thus, in both embodiments, the two-component composition can form a layer on the surface of the substrate. This layer may have a thickness of 1 μm to 500 mm, preferably 10 μm to 100 mm, and more preferably 10 μm to 10 mm.

According to certain embodiments, the two-component composition according to the invention can be used as an adhesive composition, so as to bond two substrates together. Thus, after crosslinking, the composition can form an adhesive layer holding two substrates fixed together. More particularly, after coating the two-component composition on the surface of a substrate, the surface of an additional substrate can be brought into contact with the coated surface, so as to bond the two substrates. According to certain embodiments, bringing the additional substrate into contact with the coated surface, the assembly can be placed under a heating press so as to accelerate the bonding of the two substrates together. The temperature of this press can be for example from 60 to 110° C., and preferably from 80 to 100° C.

Preferably, at least one of the two substrates is a substrate having a low surface energy. The second substrate can also be a substrate having a low surface energy. Alternatively, the second substrate may be a material chosen from paper, a metal such as aluminum, a polymeric material other than low surface energy substrates, such as polyamides, polystyrene, vinyl polymers such as polyvinyl chloride, polyethers, polyurethanes, polyesters, acrylonitrile-butadiene-styrene, poly(methyl methacrylate), poly(vinylidene fluoride), polytetrafluoroethylene, polyvinyl fluoride and natural or synthetic rubber.

According to other embodiments, the two-component composition according to the invention can be used as a coating on the surface of a substrate. Thus, after crosslinking, the composition can form a layer covering the surface of the substrate in order for example to modify one or more properties of its surface. Preferably, this substrate has a low surface energy, as described above.

According to yet other embodiments, the two-component composition according to the invention can be used as a primer. The term “primer” is understood to mean a layer coated on a substrate so as to improve one or more surface properties of this substrate (for example so as to improve the adhesion of the substrate to a material), so that additional layers can be applied to the substrate comprising the primer layer. For example, the coating of the two-component composition according to the invention on a low surface energy substrate can make it possible to increase the surface energy thereof in order to facilitate the application of another adhesive composition above the two-component composition.

Thus, the articles manufactured after application of the composition according to the invention comprise at least one surface coated with the two-component composition.

When the two-component composition is used as a primer or coating, this is an external surface of the article.

When the two-component composition is used as an adhesive, this is an internal surface of the article, that is to say a surface of the article which is in contact with, for example, another surface of the article, with the two-component composition being located between these two surfaces.

### EXAMPLE

The example that follows illustrates the invention without limiting it.

Six two-component compositions (A to F) were prepared by mixing a part A with a part B.

Parts A and B were prepared in an amount of 100 g each.

These two parts were mixed at a ratio of part A to part B of 0.1.

Part A of compositions A to F comprises 25% of a triethylborane-1,3-diaminopropane complex and 75% of an alkylsulfonate plasticizer (Mesamoll sold by Lanxess). Part B for each of the compositions A to F is detailed in the table below and it may, depending on the composition, comprise:

a polyurethane with isocyanate ends (from 17.7% to 18.3% isocyanate groups),

a polyurethane comprising acrylic groups and isocyanate groups (with an NCO content of 10.4%) (CN9303 sold by Sartomer),

a polyurethane comprising 3% methacrylic groups and 15% isocyanate groups (referred to here as polyurethane 1),

a polyurethane comprising 7% methacrylic groups and 11% isocyanate groups (referred to here as polyurethane 2),

a polyurethane comprising 13% methacrylic groups and 5% isocyanate groups (referred to here as polyurethane 3),

tetrahydrofurfuryl methacrylate (SR203 sold by Sartomer),

a hydrophobic pyrogenic silica (Aerosil® R202 sold by Evonik),

glass beads (SiO₂).

Composition F is a comparative example.

TABLE 1

| Compositions | A | B | C | D | E | F |
|---|---|---|---|---|---|---|
| Polyurethane with | 15 | — | 15 | 15 | 15 | 35 |
| isocyanate ends (%) | | | | | | |
| CN9303 | 20 | 35 | — | — | — | — |
| Polyurethane 1 | — | — | 20 | — | — | — |
| Polyurethane 2 | — | — | — | 20 | — | — |
| Polyurethane 3 | — | — | — | — | 20 | — |
| SR203 | 59 | 59 | 59 | 59 | 59 | 59 |
| Aerosil ® R202 | 5 | 5 | 5 | 5 | 5 | 5 |
| SiO₂ | 1 | 1 | 1 | 1 | 1 | 1 |

In this example, each composition (A to F) was coated on a surface (25 mm×12 mm) of a polypropylene substrate having dimensions of 100 mm×25 mm×5 mm. A second substrate of the same type is then brought into contact with the substrate comprising the two-component composition so as to bond the two substrates together. The two substrates are held against one another with clamps for 14 days. The shear strength of the manufactured articles is then tested using a universal testing machine at a rate of 10 mm/min. The values obtained correspond to an average of 3 measurements. The shear strength is reported with the failure mode.

As illustrated in the table below, composition F (comprising an acrylate as well as a polyurethane comprising isocyanate ends) was compared with compositions A to E comprising a polyurethane comprising acrylic groups and isocyanate groups.

TABLE 2

| Compositions | Shear strength (MPa) | Failure mode |
|---|---|---|
| A | 8 | SF |
| B | 5.1 | SF |
| C | 4.5 | CF |
| D | 6.1 | CF |
| E | 6.7 | CF |
| F | 4.2 | CF |

CF = cohesive failure
SF = support failure

It is noted that for the two-component compositions according to the invention (A to E), the shear strength is greater than that obtained for composition F, which means that the articles manufactured from compositions A to E have improved adhesive properties.

1-15. (canceled)

16. A two-component composition comprising:
a part A comprising a complex of organoborane with an amine;
a part B comprising a polymer comprising at least one acrylic group and at least one isocyanate group;
the composition comprising at least one acrylic monomer or oligomer in part A and/or in part B of the composition.

17. The composition as claimed in claim 16, wherein the organoborane is of formula (I): 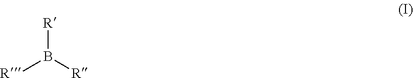
wherein R′, R″ and R′″ independently represent a group comprising from 1 to 20 carbon atoms, the group being linear or branched and being selected from the group consisting of an alkyl group, a cycloalkyl group, and an aryl group.

18. The composition as claimed in claim 16, wherein:
the amine is of formula (II): 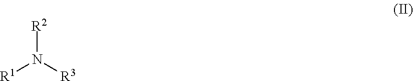
wherein R¹, R² and R³ independently represent a hydrogen atom or a group comprising from 1 to 20 carbon atoms, the group being linear or branched and saturated or unsaturated and being selected from the group consisting of an alkyl group, a cycloalkyl group, and an aryl group;
or the amine is of formula (III): 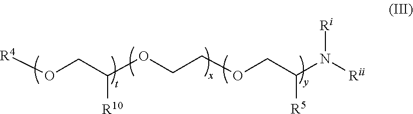
wherein R⁴, R⁵ and R¹⁰ independently represent a hydrogen atom or a group comprising from 1 to 10 carbon atoms, the group being linear or branched and saturated or unsaturated and being selected from the group consisting of an alkyl group, a cycloalkyl group, and an aryl group, Rⁱ and Rⁱⁱ independently represent a hydrogen atom or a group comprising from 1 to 20 carbon atoms, the group being linear or branched and saturated or unsaturated and being chosen from an alkyl group, a cycloalkyl group, or an aryl group, and t, x and y independently represent a number from 0 to 90;
or the amine is of formula (IV): 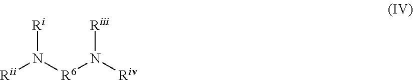
wherein R⁶ represents a divalent group comprising from 2 to 60 carbon atoms, the group being linear or branched and saturated or unsaturated and being selected from the group consisting of a divalent alkyl radical, a divalent cycloalkyl radical, a divalent arylalkyl radical, and a divalent aryl radical, and Rⁱ, Rⁱⁱ, Rⁱⁱⁱ and R^{iv} independently represent a hydrogen atom or a group comprising from 1 to 20 carbon atoms, the group being linear or branched and saturated or unsaturated and being selected from the group consisting of an alkyl group, a cycloalkyl group, and an aryl group;
or the amine is of formula (V): 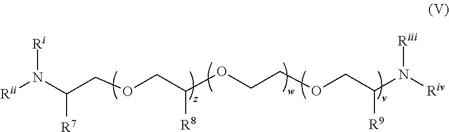
wherein R⁷, R⁸ and R⁹ independently represent a group comprising from 1 to 10 carbon atoms, the group being linear or branched and saturated or unsaturated and being selected from the group consisting of an alkyl group, a cycloalkyl group, and an aryl group, Rⁱ, Rⁱⁱ, Rⁱⁱⁱ and R^{iv} independently represent a hydrogen atom or a group comprising from 1 to 20 carbon atoms, the group being linear or branched and saturated or unsaturated and being selected from the group consisting of an alkyl group, a cycloalkyl group, and an aryl group, and v, w and z independently represent a number from 0 to 90;
or the amine is of formula (VI): 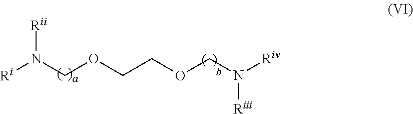
wherein Rⁱ, Rⁱⁱ, Rⁱⁱⁱ and R^{iv} independently represent a hydrogen atom or a group comprising from 1 to 20 carbon atoms, the group being linear or branched and saturated or unsaturated and being selected from the group consisting of an alkyl group, a cycloalkyl group, and an aryl group; a and b independently represent a number from 1 to 20;
or the amine is of formula (VII): 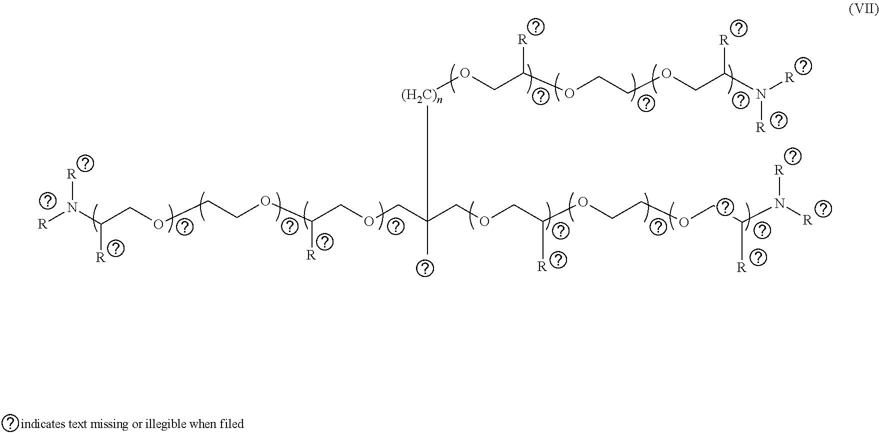
wherein R₁⁸, R₁^{g}, R₂⁸, R₂⁹, R₂⁹, R₃⁸, and R₃⁹ independently represent a group comprising from 1 to 10 carbon atoms, the group being linear or branched and being selected from the group consisting of an alkyl group, a cycloalkyl group, and an aryl group, R represents a hydrogen atom or a group comprising from 1 to 10 carbon atoms, the group being linear or branched and being selected from the group consisting of an alkyl group, a cycloalkyl group, and an aryl group, Rⁱ, Rⁱⁱ, Rⁱⁱⁱ and R^{iv} independently represent a hydrogen atom or a group comprising from 1 to 20 carbon atoms, the group being linear or branched and saturated or unsaturated and being selected from the group consisting of an alkyl group, a cycloalkyl group, and an aryl group, n represents a number from 0 to 30 and the sums z₁+z₂+z₃, v₁+v₂+v₃ and w₁+w₂+w₃ independently represent a number from 0 to 90.

19. The composition as claimed in claim 16, wherein the organoborane complex with the amine comprises triethylborane-1,3-diaminopropane, tri-n-butylborane-3-methoxypropylamine, triethylborane-diethylenetriamine, tri-n-butylborane-1,3-diaminopropane, tri-sec-butylborane-1,3-diaminopropane and triethylborane-1,6-hexanediamine, and/or wherein the complex of organoborane with an amine is present in part A at a content by mass of 5% to 100%, relative to the total of part A.

20. The composition as claimed in claim 16, wherein the polymer comprising at least one acrylic group and at least one isocyanate group is a polyurethane.

21. The composition as claimed in claim 16, wherein the polymer comprising at least one acrylic group and at least one isocyanate group has a number-average molecular mass of 500 to 50 000 g/mol and/or wherein the polymer comprises from 0.5 to 3 isocyanate groups per mole of polymer, and/or from 0.5 to 4 acrylic groups per mole of polymer.

22. The composition as claimed in claim 16, wherein the acrylic group is selected from the group consisting of acrylic esters and acrylamides.

23. The composition as claimed in claim 16, wherein the polymer comprising at least one acrylate group and at least one isocyanate group is present in part B at a content by mass of 1% to 70%, relative to the total of part B.

24. The composition as claimed in claim 16, wherein the mass ratio of part A to part B is from 0.05 to 10.

25. An adhesive comprising the composition of claim 16, wherein the adhesive is used for binding two substrates together, or as a coating on a surface of a substrate, or as a primer on a surface of a substrate.

26. The adhesive of claim 25, wherein the substrate or at least one of the two substrates has a surface energy of less than or equal to 45 mJ/m².

27. An article comprising at least one layer obtained by crosslinking the composition of claim 16.

28. The article as claimed in claim 27, wherein the layer is an adhesive layer.

29. A method for preparing the article of claim 27, comprising:
mixing part A of the composition with part B of the composition; and
coating the mixture on a surface of a substrate;
optionally bringing the surface of the substrate into contact with a surface of an additional substrate.

30. A method for preparing the article of claim 27, comprising:
coating one of parts A or B of the composition on a surface of a substrate; and
coating the second of parts A or B of the composition on the surface of the substrate;
optionally bringing the surface of the substrate into contact with a surface of an additional substrate.

31. The composition of claim 18, wherein the amine is selected from the group consisting of tert-butylamine, 3-methoxypropylamine, 1,3-propanediamine, 1,6-hexanediamine, and diethylenetriamine.
